(19) United States
(12) Patent Application Publication
(10) Pub. No.: US 2019/0068355 A1
(43) Pub. Date: Feb. 28, 2019

(54) RADIO COMMUNICATION SYSTEM, BASE STATION, AND RADIO TERMINAL

(71) Applicant: FUJITSU LIMITED, Kawasaki-shi (JP)

(72) Inventor: Takayoshi Ode, Yokohama (JP)

(73) Assignee: FUJITSU LIMITED, Kawasaki-shi (JP)

(21) Appl. No.: 16/176,747

(22) Filed: Oct. 31, 2018

Related U.S. Application Data
(63) Continuation of application No. PCT/JP2016/064062, filed on May 11, 2016.

(51) Int. Cl. H04L 5/14; H04L 5/16; H04L 5/00; H04W 72/04

(52) U.S. Cl. CPC H04L 5/1469; H04L 5/16; H04W 72/0453; H04L 5/0098; H04W 72/0446; H04L 5/001

(57) ABSTRACT

A radio communication system includes a base station configured to set a first radio resource for performing full duplex communication and a second radio resource for performing half duplex communication in one frequency band, and a radio terminal configured to communicate with the base station by using at least one of the first radio resource and the second radio resource.

### CROSS-REFERENCE TO RELATED APPLICATION

This application is a continuation application of International Application PCT/JP2016/064062 filed on May 11, 2016 and designated the U.S., the entire contents of which are incorporated herein by reference.

### FIELD

The technology described in this specification relates to a radio communication system, a base station, and a radio terminal.

### BACKGROUND

Full duplex (FD) communication and half duplex (HD) communication are known as modes of communication.

In the FD communication, reception may be performed while performing transmission. The FD communication is performed by frequency division duplex (FDD) using two different radio frequencies for the transmission and the reception.

In the HD communication, on the other hand, only one of transmission and reception is performed at a certain time. The HD communication is performed by time division duplex (TDD) where transmission and reception are temporally divided using the same frequency for the transmission and reception, for example.

Examples of the related art include Japanese National Publication of International Patent Application No. 2014-533900, and Japanese Laid-open Patent Publication No. 2015-201875.

Examples of the related art include: Xi Zhang et al., “Filtered-OFDM-Enabler for Flexible WaveForm in The 5^{th} Generation Cellular Networks”, December 2015, Accepted to IEEE Globecom, San Diego, Calif.; Javad Abdoli et al., “Filtered OFDM: A new Waveform for Future Wireless Systems”, 2015, IEEE, 16^{th} International Workshop on Signal Processing Advances in Wireless Communications (SPAWC); and Thorsten Wild et al., “5G Air Interface Design based on Universal Filtered (UF-) OFDM”, August 2014, IEEE, Proceedings of the 19^{th} International Conference on Digital Signal Processing.

### SUMMARY

According to an aspect of the invention, a radio communication system includes a base station configured to set a first radio resource for performing full duplex communication and a second radio resource for performing half duplex communication in one frequency band, and a radio terminal configured to communicate with the base station by using at least one of the first radio resource and the second radio resource.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a configuration example of a radio communication system according to an embodiment;

FIG. 2 is a diagram illustrating radio resources divided into two dimensions of frequency and time according to the embodiment.

FIG. 3 is a diagram illustrating a format example of a radio frame according to the embodiment;

FIG. 4 is a diagram illustrating an example of asubband according to the embodiment;

FIG. 5 is a diagram illustrating an example of radio resources corresponding to FIG. 4;

FIG. 6 is a sequence diagram illustrating an operation example of the radio communication system illustrated in FIG. 1;

FIG. 7 is a sequence diagram illustrating an example where inter-signal interferences occur in FIG. 6;

FIG. 8 is a sequence diagram illustrating an example of a contention-based random access procedure;

FIG. 9 is a sequence diagram illustrating an example of a non-contention-based random access procedure;

FIG. 10 is a diagram illustrating an example of setting resources for FDD-based FD and HD communications according to the embodiment;

FIG. 11 is a diagram illustrating an example of setting resources for TDD-based FD and HD communications according to the embodiment;

FIG. 12 is a sequence diagram illustrating an operation example in a first example;

FIG. 13 is a sequence diagram illustrating an operation example in a second example;

FIG. 14 is a sequence diagram illustrating an operation example in a third example;

FIG. 15 is a sequence diagram illustrating an operation example in a fourth example;

FIG. 16 is a diagram illustrating a model example of interference caused by adjacent channel power;

FIG. 17 is a diagram illustrating a GAP setting example in the FDD according to the embodiment;

FIG. 18 is a diagram illustrating a GAP setting example in the FDD according to the embodiment;

FIG. 19 is a schematic diagram for explaining possible inter-signal interference caused when no GAP is set in the TDD;

FIG. 20 is a schematic diagram for explaining possible inter-signal interference caused when no GAP is set in the TDD;

FIG. 21 is a diagram illustrating a GAP setting example in the TDD according to the embodiment;

FIG. 22A is a diagram illustrating format examples of a special subframe (SSF);

22B. is a diagram illustrating format examples of a special subframe (SSF);

FIG. 23 is a diagram illustrating an SSF (GAP) setting example in the TDD according to the embodiment;

FIG. 24 is a diagram illustrating an SSF (GAP) setting example in the TDD according to the embodiment;

FIG. 25 is a diagram illustrating a resource setting example for the FD and HD communications in the TDD and FDD according to the embodiment;

FIG. 26 is a diagram illustrating an example where the SSF (GAP) is set in FIG. 25;

FIG. 27 is a diagram illustrating an example where the SSF (GAP) is set in FIG. 25;

FIG. 28 is a diagram illustrating an example where the SSF (GAP) is set in FIG. 25;

FIG. 29 is a block diagram illustrating a first configuration example of a base station (eNB) illustrated in FIG. 1;

FIG. 30 is a block diagram illustrating a first configuration example of a radio terminal (UE) illustrated in FIG. 1;

FIG. 31 is a block diagram illustrating a second configuration example of the base station (eNB) illustrated in FIG. 1;

FIG. 32 is a block diagram illustrating a second configuration example of the radio terminal (UE) illustrated in FIG. 1;

FIG. 33 is a block diagram illustrating a third configuration example of the base station (eNB) illustrated in FIG. 1; and

FIG. 34 is a block diagram illustrating a third configuration example of the radio terminal (UE) illustrated in FIG. 1.

### DESCRIPTION OF EMBODIMENTS

In a radio communication system, when it is attempted to perform FD communication in one frequency band between a base station and a radio terminal, for example, inter-signal interference may occur between the base stations, between the radio terminals, or between the base station and the radio terminal.

When such inter-signal interference occurs in information or signal used to start communication by establishing a radio link (which may be referred to as the “radio channel”) between the base station and radio terminal, time that takes to enable the communication may be extended or a communication rate may be lowered. In the worst-case scenario, the communication is disabled.

Hereinafter, embodiments of the technology to enable suppression of inter-signal interference even when full duplex communication is performed in one frequency band are described with reference to the drawings. Note, however, that the embodiments described below are for illustrative purposes only, and do not intend to exclude various modifications and technical applications that are not specified below. Moreover, various exemplary aspects described below may be accordingly combined and implemented. Note that, throughout the drawings used in the following embodiments, portions to which the same reference numerals are given indicate the same or equivalent portions unless otherwise stated.

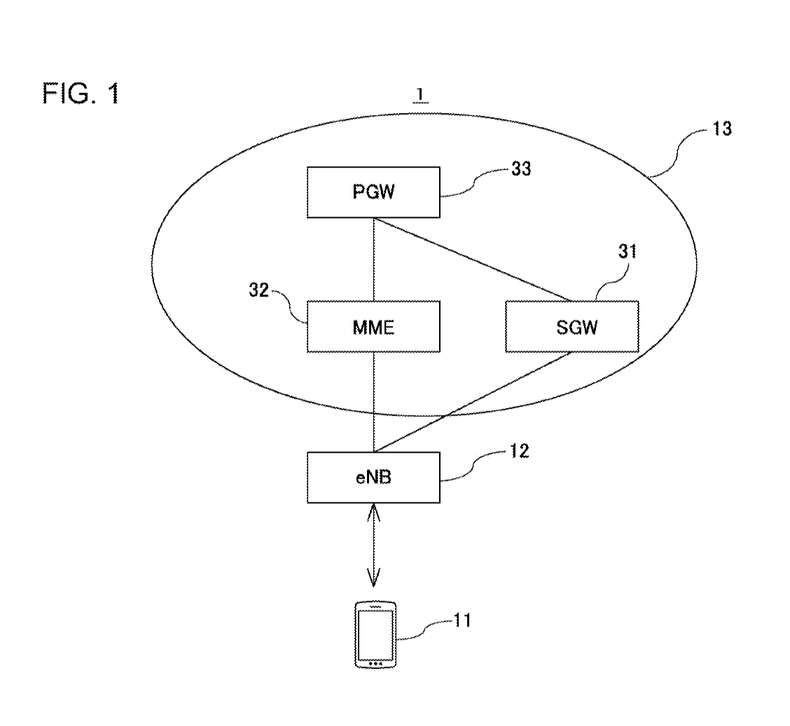

FIG. 1 is a block diagram illustrating a configuration example of a radio communication system according to an embodiment. A radio communication system 1 illustrated in FIG. 1 may include, as an example, a radio terminal 11, a base station 12, and a core network 13. Note that, although one radio terminal 11 and one base station 12 are illustrated in the example of FIG. 1, two or more radio terminals 11 and two or more base stations 12 may be provided in the radio communication system 1.

The radio terminal 11 may perform radio communication with the base station 12 in a radio area formed or provided by the base station 12. The “radio terminal” may also be referred to as the “radio device”, “radio unit”, “terminal device”, or the like.

The radio terminal 11 may be either a fixed terminal whose position does not change or a mobile terminal (which may also be referred to as the “mobile equipment”) whose position changes. As a non-limiting example, the radio terminal 11 may be a mobile UE such as a cell-phone, a smartphone, and a tablet terminal. “UE” stands for “User Equipment”.

The base station 12 forms or provides a radio area that allows radio communication with the radio terminal 11. The “radio area” may also be referred to as the “cell”, “coverage area”, “communication area”, “service area”, or the like.

The base station 12 may be, as an example, “eNB” compliant with LTE or LTE-Advanced (hereinafter collectively referred to as the “LTE”) of the 3GPP. “eNB” stands for “enhanced Node B”. Note that a communication point (called RRE (Remote Radio Equipment) or RRH (Remote Radio Head)) separated from the base station itself and disposed in a remote location may correspond to the base station 12. Alternatively, the base station 12 may be a relay device that relays communication with the radio terminal 11. The relay device may correspond to “RN” compliant with the LTE of the 3GPP. “RN” stands for “Relay Node”.

A “cell” formed or provided by the base station 12 may be divided into “sector cells”. The “cell” may include a macro cell or a small cell. The small cell is an example of a cell having a coverage smaller than that of the macro cell.

The small cell may be called differently depending on the coverage area. For example, the small cell may also be referred to as the “femtocell”, “picocell”, “microcell”, “nanocell”, “metro cell”, “home cell”, or the like.

As illustrated in FIG. 1, the core network 13 may include an SGW 31, an MME 32, and a PGW 33. “SGW” stands for “Serving Gateway”. “PGW” stands for “Packet Data Network Gateway”. “MME” stands for “Mobility Management Entity”.

The core network 13 may be considered as corresponding to an “upper network” for the base station 12. The SGW 31, the MME 32, and the PGW 33 may be considered as corresponding to elements (NE) or entities of the “core network”, and may be collectively referred to as the “core nodes”.

The base station 12 may be connected to the core network 13 through an “S1 interface” that is an example of a wired interface. Note, however, that the base station 12 may be communicably connected to the core network 13 through a radio interface.

A network including the base station 12 and the core network 13 may be referred to as the “radio access network (RAN)”. An example of the RAN is “Evolved Universal Terrestrial Radio Access Network (E-UTRAN)”.

As an example, the base station 12 may be communicably connected to the SGW 31 and the MME 32. The base station 12 may be communicably connected to the SGW 31 and the MME 32 through an interface called the S1 interface, for example.

The SGW 31 may be communicably connected to the PGW 33 through an interface called an S5 interface. The PGW 33 may be communicably connected to a packet data network (PDN) such as the Internet and an intranet.

Through the SGW 31 and the PGW 33, user packets may be transmitted and received between the radio terminal 11 and the PDN. The user packets are an example of user data, and may be referred to as the user plane signals.

As an example, the SGW 31 may process the user plane signal. A control plane signal may be processed by the MME 32. The SGW 31 may be communicably connected to the MME 32 through an interface called an S11 interface.

As an example, the MME 32 manages positional information on the radio terminal 11. The SGW 31 may perform movement control such as path switching of the user plane signal upon movement of the radio terminal 11, for example, based on the positional information managed by the MME 32. The movement control may include control associated with handover of the radio terminal 11.

The radio area formed by the eNB may be a “cell” or a “sector”. The cell formed by the eNB may be referred to as the “macro cell”. A radio base station (eNB) that forms the macro cell may also be referred to as the “macro base station”, “macro eNB”, “MeNB”, or the like.

Note that the “cell” is an example of the radio area formed according to a range that may be reached by radio waves transmitted by the radio base station (which may also be referred to as the “coverage”). A radio device such as a mobile station located within a cell may perform radio communication with a radio base station that forms the cell.

In the LTE, there have been discussions conducted regarding a technology to increase a system capacity by using a small cell (SC) besides the macro cell. For example, a “small cell” having a coverage smaller than that of the macro cell (MC) may be disposed in the macro cell.

As an example, the “small cell” may include a cell called a “home cell”, “femtocell”, “picocell”, “microcell”, “metro cell”, or the like.

The base station 12 may control setting (which may also be referred to as “assignment”) of radio resources for use in communication with the radio terminal 11. This control may also be referred to as “scheduling”. The radio resources (which may also be simply referred to as the “resources”) may be divided two-dimensionally by a frequency domain and a time domain.

The base station 12 may perform scheduling of the radio resources usable for communication with the radio terminal 11, using the unit divided by the frequency domain and the time domain.

Either time division duplex (TDD) or frequency division duplex (FDD) may be applied to the radio communication between the radio terminal 11 and the base station 12.

In the TDD, one frequency (or frequency band) is used to perform downlink (DL) communication and uplink (UL) communication at different times.

For example, the base station 12 schedules the DL communication and the UL communication at different times in one frequency band for the radio terminal 11. Therefore, the base station 12 and the radio terminal 11 perform transmission and reception at different times in one frequency band.

On the other hand, in the FDD, the DL communication and the UL communication are performed using different frequencies (or frequency bands).

For example, the base station 12 may schedule the DL communication and the UL communication at different frequencies regardless of communication timing. Therefore, the base station 12 and the radio terminal 11 may perform reception using a frequency different from the transmission frequency while performing transmission.

The FDD is an example of full duplex (FD) communication, since transmission and reception may be performed at the same time. The TDD is an example of half duplex (HD) communication, since transmission and reception may not be performed at the same time in one frequency band (if performed, inter-signal interference occurs to disable communication).

Note, however, that a function or processing to remove or suppress the inter-signal interference (which may be hereinafter referred to as the “interference suppression function” or “interference suppression processing”) may be applied to realize the FD communication in one frequency band.

For example, a scrambling code assigned to each radio terminal 11 is used to enable identification of a signal for each radio terminal 11. Thus, inter-signal interference between the radio terminals 11 may be removed or suppressed. The “scrambling code” may also be referred to as the “spreading code”.

Note that, while “scrambling” is multiplication of 1-bit information by 1-bit or multi-bit code, “spreading” is multiplication of 1-bit information by multi-bit information. Therefore, “scrambling” is a broader concept including “spreading”.

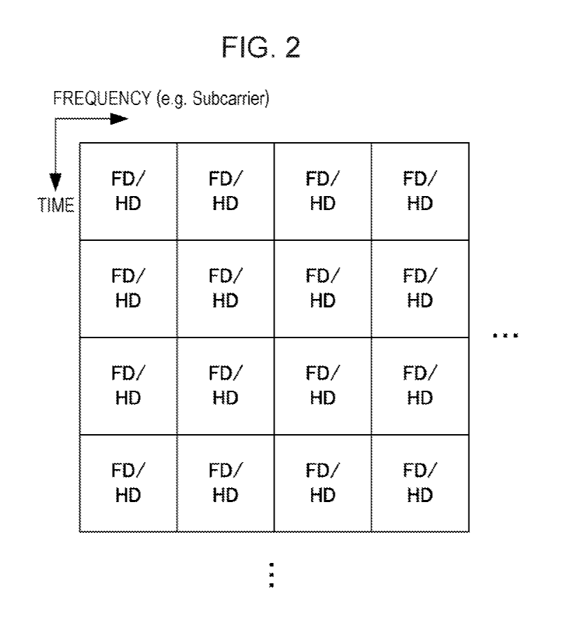

With the application of the interference suppression function, in any of the cases of TDD and FDD, the base station 12 is allowed to set radio resources represented by the grid of frequency and time for either the FD communication or the HD communication in each of the cells of the grid as illustrated in FIG. 2.

Note that one resource block (RB) of the LTE may be considered as corresponding to one of the cells of the grid illustrated in FIG. 2. Alternatively, one component carrier (CC) in a carrier aggregation (CA) may be considered as corresponding to one row of cells of the grid illustrated in FIG. 2.

The RB of the LTE corresponds to one block obtained by dividing the radio resources usable for communication with the radio terminal 11 by the slot in the time domain and a plurality of subcarriers adjacent to each other in the frequency domain.

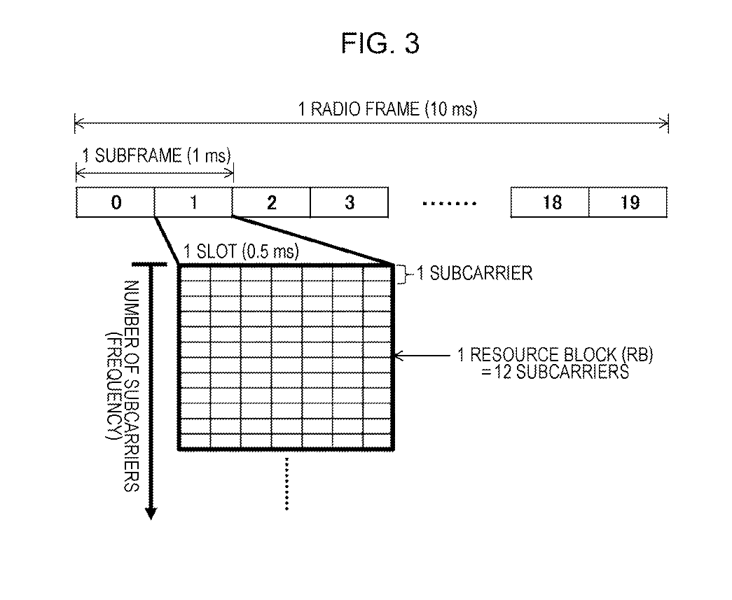

For example, as illustrated in FIG. 3, in the LTE, a radio frame includes ten 1 ms long subframes, and thus the length of the radio frame is 10 ms. One subframe includes two 0.5 ms long slots, for example.

One slot includes seven symbols in the case of using a normal cyclic prefix (CP), and includes six symbols in the case of using an extended CP that is temporally longer than the normal CP. The RB is represented by 2 slots (=1 subframe)×12 subcarriers, for example. Note that the CP in the LTE may be generally called a guard interval (GI), or may also be called a redundant portion since the latter half portion of the waveform of the symbol is copied and used.

The CC corresponds to one of a plurality of carrier frequency (band) groups bundled together by the CA.

Moreover, one subcarrier block (SCB) in F-OADM or UF-OFDM that is an extended version of OFDM (or OFDMA) may be considered as corresponding to one row of cells of the grid illustrated in FIG. 2.

“OFDM” stands for “Orthogonal Frequency Division Multiplexing”, while “OFDMA” stands for “Orthogonal Frequency Division Multiple Access”. F-OFDM stands for “Filtered-OFDM”, while UF-OFDM stands for “Universal Filtered-OFDM”.

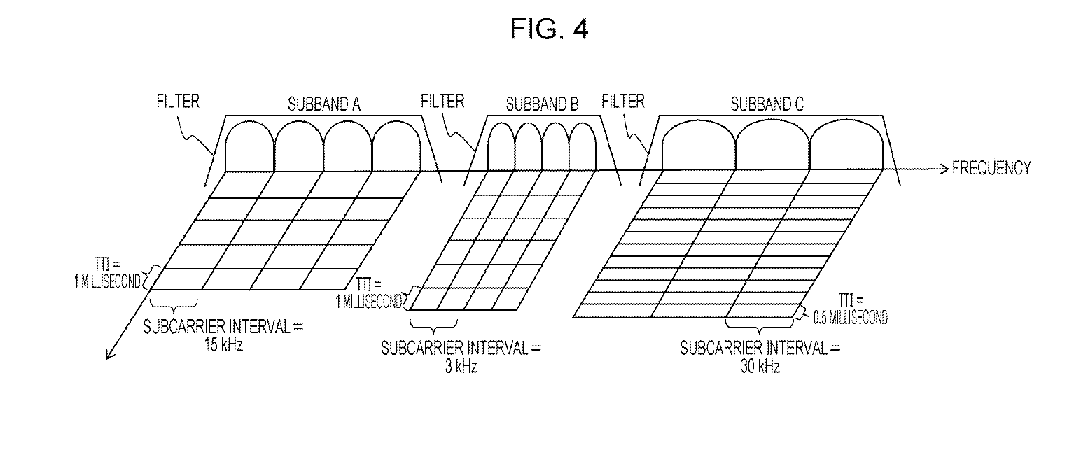

The SCB may also be referred to as “subband” or “cluster” in the F-OFDM or UF-OFDM. The subband in the F-OFDM or UF-OFDM corresponds to one of the bands obtained by dividing the frequency band (which may also be referred to as the “system band”) usable for communication with the radio terminal 11, as illustrated in FIG. 4, for example. For example, a plurality of subcarriers may be bundled together as a subband or cluster.

As illustrated in FIG. 4, between the subbands, gaps (GAPs) are provided according to signal waveform shaping (which may also be referred to as “filtering”) using filters. Therefore, unlike between the subcarriers in the OFDM, orthogonality does not have to be maintained between the subbands. Moreover, the number of subcarriers, subcarrier interval, transmission time interval (TTI), and the like are also allowed to differ between the subbands.

For example, the number of subcarriers, the number of symbols, symbol length, slot length, radio frame length, subframe length (in other words, TTI), and the like may differ between the subbands. These parameters may be fixed within one subband.

In other words, the number of subcarriers, the number of symbols, symbol length, slot length, radio frame length, and subframe length (TTI) are allowed to be variable for each cluster by filtering of each cluster in the F-OFDM or UF-OFDM.

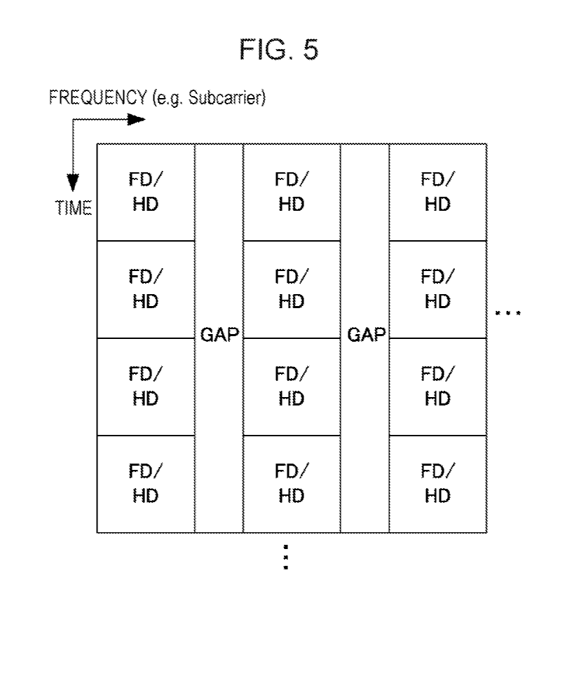

FIG. 5 illustrates an example where radio resources in the F-OFDM or UF-OFDM are divided into the grid of frequency and time on the assumption that there are gaps between the subbands.

As illustrated in FIG. 5, in the F-OFDM or UF-OFDM, the base station 12 may set the radio resources represented by the grid except for the gaps to FD or HD in each of the cells of the frequency-time grid.

Note, however, that there is also a case where the radio terminal 11 does not know (in other words, does not store) information (for example, the scrambling code described above) for removing or suppressing the inter-signal interference. In other words, not every radio terminal 11 that tries to connect to the base station 12 supports the function or processing to remove or suppress the inter-signal interference (which may be hereinafter referred to as the “interference suppression function” or “interference suppression processing”) using the scrambling code.

In such a case, setting a certain frequency band as a band for FD communication may bring about the radio terminal 11 that may not establish connection with the base station 12 due to the inter-signal interference in the certain frequency band.

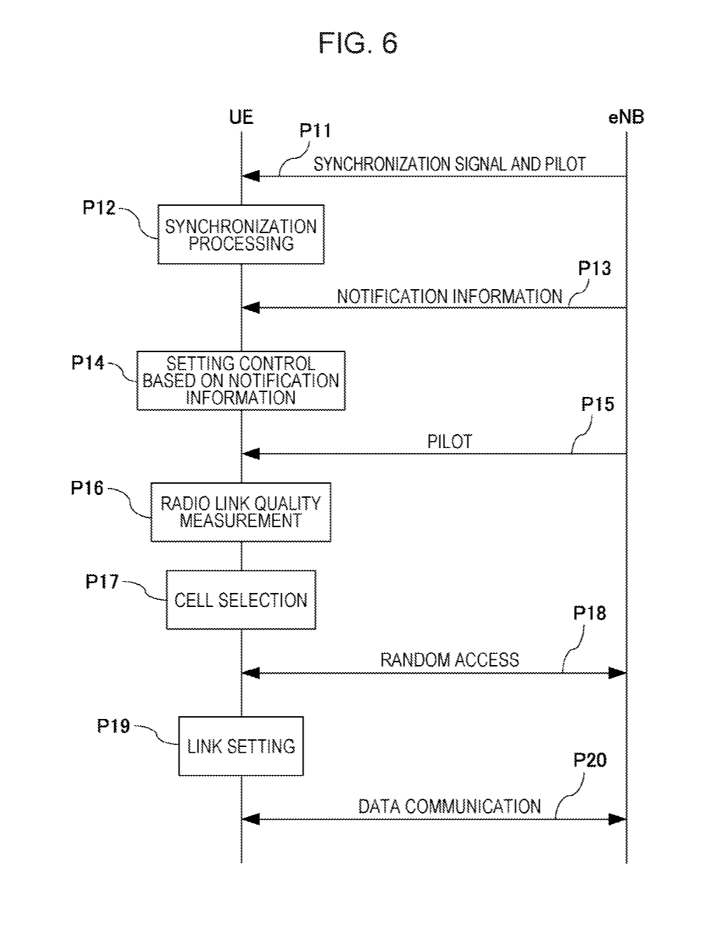

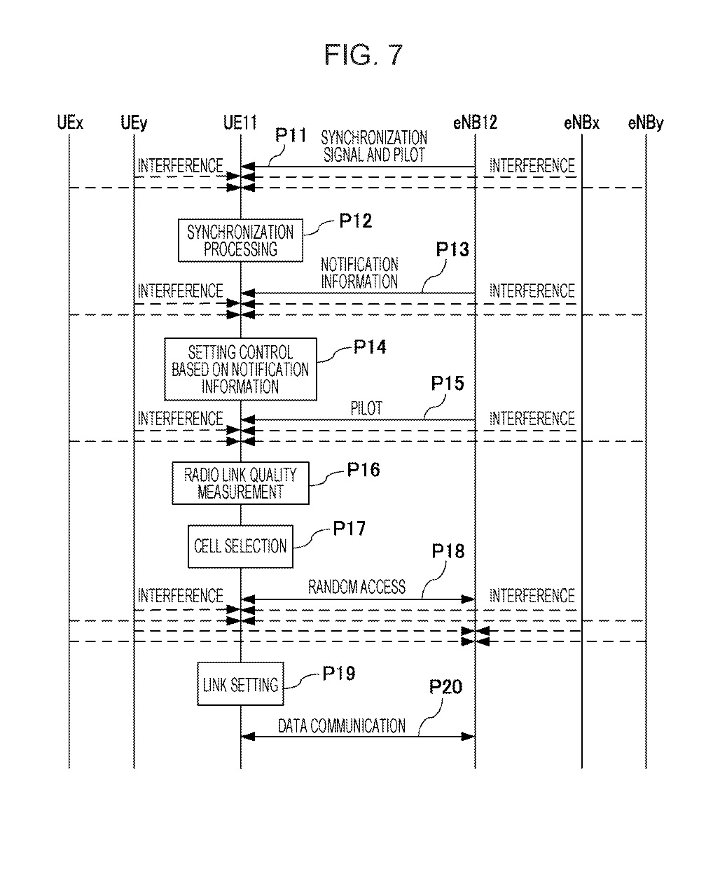

With reference to FIGS. 6 and 7, description is given of an example where the inter-signal interference occurs. FIG. 6 is a sequence diagram illustrating an example of processing until a UE that is an example of the radio terminal 11 starts data communication with an eNB that is an example of the base station 12 after establishing connection with the base station 12. FIG. 7 is a sequence diagram illustrating how interferences occur in signals transmitted and received between the UE 11 and the eNB 12 in the processing of FIG. 6.

As illustrated in FIG. 6, upon receipt of a synchronization signal and a pilot signal transmitted by the eNB 12 in Process P11, the UE 11 may perform synchronization processing using the received synchronization signal and pilot signal (Process P12). The pilot signal may also be referred to as a reference signal (RS). Furthermore, the pilot signal may be a known signal of the UE 11. In the synchronization processing, symbol timing detection, scrambling code detection, frame timing detection, and the like may be performed.

Then, upon receipt of notification (broadcast) information transmitted by the eNB 12 in Process P13, the UE 11 may perform setting control based on the notification information (Process P14).

The “notification information” may include, as a non-limiting example, system information, information regarding radio resource control (RRC), and the like. The system information may include, as an example, a master information block (MIB) and a system information block (SIB).

The “setting control based on the notification information” may be setting for measurement of radio link quality, setting for cell selection (such as, for example, parameter setting), and the like, for example. In addition, setting of subsequent random access, setting regarding RRC connection, setting for data communication, and the like may also be included in the “setting control based on the notification information”. Note that the “radio link” may also be referred to as the “radio channel”.

After the “setting control based on the notification information”, the UE 11 may measure DL radio channel quality upon receipt of the pilot signal transmitted by the eNB 12 in Process P15 (Process P16). The pilot signal may be a common pilot signal for DL. As an example, the common pilot signal may be either a cell common RS or a cell specific RS.

An indicator of the “radio channel quality” to be measured may be, as an example, RS received power (RSRP), RS received quality (RSRQ), channel quality indicator (CQI), channel state information (CSI), or the like.

Based on the result of the measurement of the radio channel quality, the UE 11 may perform cell selection (Process P17). Thereafter, the UE 11 may perform a random access (RA) procedure for the eNB 12 that provides cells to be selected (Process P18).

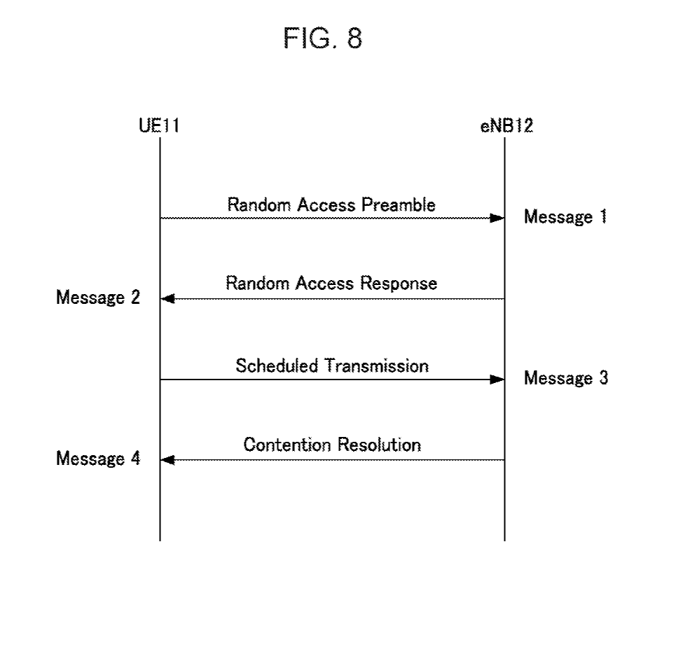

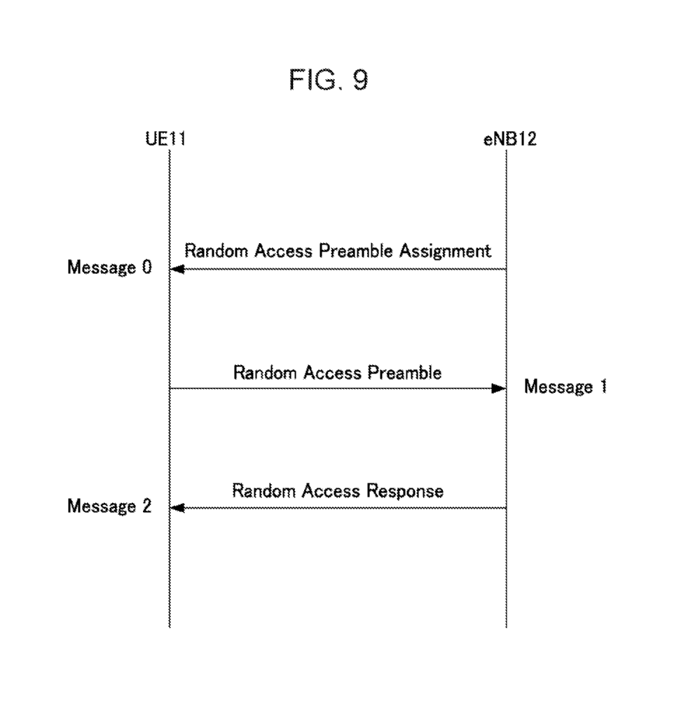

The RA procedure may be either contention-based or non-contention-based. FIG. 8 illustrates an example of a contention-based RA procedure, while FIG. 9 illustrates an example of a non-contention-based RA procedure.

### Contention-Based RA Procedure

In the contention-based RA procedure, as illustrated in FIG. 8, the UE 11 transmits an RA preamble as a message 1 to the eNB 12 through a random access channel (RACH).

After successfully receiving the RA preamble transmitted by the UE 11, the eNB 12 transmits an RA response as a message 2 to the UE 11. The RA response may include a transmission permit for UL common channel, an identifier temporarily assigned to identify the UE 11 to be subjected to subsequent RA procedure, and the like. The identifier may be, as an example, “temporary-cell radio network temporary identifier (T-CRNTI)”. The RA response may be transmitted using a DL common channel, for example.

Upon receipt of the RA response from the eNB 12, the UE 11 performs transmission (Scheduled Transmission) of a UL message 3. The message 3 may include “temporary mobile subscriber identity (TMSI)” as an example of the temporary identifier for the UE 11.

As an example, when a plurality of UEs 11 transmit contending RA preambles at the same time, the TMSI may be used to identify the contending UEs 11 for contention resolution between the UEs 11.

The eNB 12 may transmit a response (message 4) called “Contention Resolution” to the UE 11 selected by the contention resolution.

Upon receipt of the response (message 4), the UE 11 may continue the communication with the eNB 12. For example, the UE 11 may use the T-CRNTI received through the RA response (message 2) as a C-RNTI (cell-RNTI) for subsequent communication.

Note that the UE 11 that has not been selected by the contention resolution at the eNB 12 and not received the message 4 starts over again the RA procedure described above by retransmitting the RA preamble (message 1).

### Non-Contention-Based RA Procedure

In contrast to the contention-based RA procedure described above, the eNB 12 previously notifies and assigns an individual RA preamble to the UE 11, as illustrated in FIG. 9, in the non-contention-based RA procedure. A message used for such notification and assignment may be referred to as the “message 0” (RA Preamble Assignment).

Upon receipt of the message 0, the UE 11 may use the RA preamble assigned by the eNB 12 through the message 0 to transmit a message 1 to the eNB 12 through the RACH.

Upon receipt of the message 1 (RA preamble) from the UE 11, the eNB 12 transmits an RA response (message 2) to the UE 11.

After successfully performing the contention-based or non-contention-based RA procedure described above, the UE 11 may set a radio channel (Process P19) as illustrated in FIG. 6. The setting of the radio channel may be, as an example, setting regarding the RRC connection.

After setting the radio channel, the UE 11 may start data communication with the eNB 12 (Process P20).

The above processing sequence (FIG. 6) is a processing sequence based on one UE 11 and one eNB 12. However, as illustrated in FIG. 7, in the radio communication system 1, there may be other E 11x and UE 11y aside from the UE 11 and also other eNB 12x and eNB 12y aside from the eNB 12.

In such a case, when the radio resources represented by the frequency-time grid illustrated in FIG. 2 are set for the FD communication without any restrictions placed thereon, interferences may occur in signals received by the UE 11 as schematically illustrated by the dotted arrows in FIG. 7.

For example, UL signals from other UEx and UEy or DL signals from other eNBx and eNBy may interfere with a synchronization signal, a pilot signal, and notification information which the UE 11 wishes to receive from the eNB 12.

Also, UL signals from other UEx and UEy or DL signals from other eNBx and eNBy may interfere with any of the messages described above in the RA procedure executed between the UE 11 and the eNB 12.

Any interference with the synchronization signal may delay the synchronization processing (Process P12 in FIGS. 6 and 7). In the worst-case scenario, synchronization may not be achieved.

Any interference with the pilot signal may reduce the measurement accuracy for the radio channel quality such as the RSRP, RSRQ, and CQI. When the measurement accuracy for the radio channel quality is reduced, the accuracy of cell selection by the UE 11 or the accuracy of UL communication scheduling by the eNB 12 may also be reduced, for example.

Any interference with the notification information such as system information notified to the UE 11 may hinder proper execution of the “setting control based on the notification information” (Process P14 in FIGS. 6 and 7) by the UE 11. Consequently, UE 11 may fail in the subsequent processing, for example, radio channel quality measurement, cell selection, setting regarding the RRC connection, and the like.

Any interference with the RA procedure may decrease the success rate of the RA procedure for the eNB 12 by the UE 11.

Therefore, in an embodiment described below, radio resources for performing HD communication rather than the FD communication are set in certain “one frequency band”. This “one frequency band” may be either a system band or a CC or SCB frequency band. Note that it may be indifferent whether or not the UE 11 already knows or does not know information regarding interference suppression processing, such as a scrambling code.

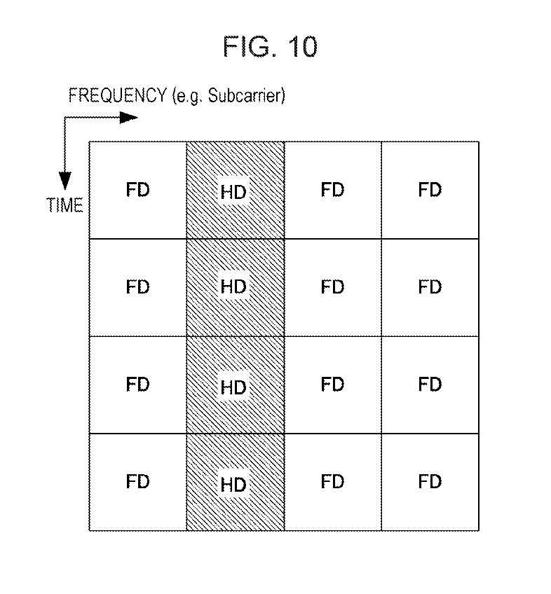

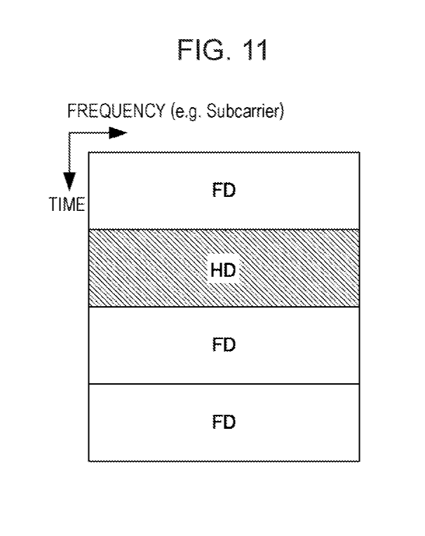

FIG. 10 illustrates an example of setting resources for FDD-based FD and HD communications, while FIG. 11 illustrates an example of setting resources for TDD-based FD and HD communications. In the examples of FIGS. 10 and 11, the frequency axis may be a subcarrier frequency.

In the example of FIG. 10, one of four frequency bands, that is, the second lowest frequency band is set to the HD communication, as a non-limiting example, and the other three frequency bands are set to the FD communication. The frequency band for the FD communication is an example of a first frequency band, while the frequency band for the HD communication is an example of a second frequency band.

Note that all the four frequency bands illustrated in FIG. 10 may correspond to the system band, or may correspond to one CC or one SCB. Moreover, in the example of FIG. 10, all four time sections in the time domain are set to the HD communication in the second frequency band. However, only some of the four time sections may be set to the HD communication.

In the example of FIG. 11, on the other hand, one of four time sections obtained by dividing one frequency band in the time domain, that is, the second earliest time section is set to the HD communication, as a non-limiting example, and the other three time sections are set to the FD communication.

Each of the time sections may correspond to the subframe length in the LTE radio frame. Also, the one frequency band illustrated in FIG. 11 may correspond to the system band, or may correspond to one CC or one SCB. Note that, in FIG. 11, the time sections for the FD communication are an example of a first time section, while the time section for the HD communication is an example of a second time section.

As illustrated in FIGS. 10 and 11, by setting at least some of the resources assignable to the UE 11 to the HD communication, the occurred of inter-signal interference as illustrated in FIG. 7 may be reduced or suppressed.

For example, the UE 11 uses radio resources set for HD to receive the synchronization signal, pilot signal, and notification information described above, and to perform the RA procedure. Thus, the success rate of the synchronization processing, the RA procedure, and the radio channel setting, as well as the cell selection accuracy and the radio channel quality measurement accuracy are increased.

### Operation Example

In the radio communication system 1 described above, the LTE-based FD communication and HD communication may be switched therebetween. In an LTE system using DFT-s-OFDM as a UL multiple access processing scheme and OFDMA as a DL multiple access processing scheme, for example, the FD communication and the HD communication may be switched therebetween.

Note that “DFT-s-OFDM” stands for “Discrete Fourier Transform Spread-OFDM”. Switching between the FD communication and the HD communication may be performed for both UL and DL, or may be performed for only one of UL and DL.

Modes of switching between the FD communication and the HD communication are as follows.

(1) In the case of TDD

(1-1) The FD communication and the HD communication are switched therebetween in the time domain (for example, by the subframe).
(1-2) The FD communication and the HD communication are switched therebetween in the frequency domain (for example, by the RB or CC).
(1-3) The FD communication and the HD communication are switched therebetween by combining (1-1) and (1-2), that is, in both of the time domain and the frequency domain.

(2) In the case of FDD

(2-1) The FD communication and the HD communication are switched therebetween in the time domain in one frequency band of one or both of DL and UL. One frequency band may be the RB, CC, or SCB
(2-2) The FD communication and the HD communication are switched therebetween in the frequency domain in one frequency band of one or both of DL and UL.
(2-3) The FD communication and the HD communication are switched therebetween by combining (2-1) and (2-2), that is, in both of the time domain and the frequency domain in one frequency band of one or both of DL and UL, for example.

Note that DFT-s-OFDM may be used as the UL multiple access processing scheme, and F-OFDM (or F-OFDMA) may be used as the DL multiple access processing scheme. In this case, again, the FD communication and the HD communication may be switched therebetween. Not only the switching between the FD communication and the HD communication but also switching between the multiple access processing schemes may be achieved.

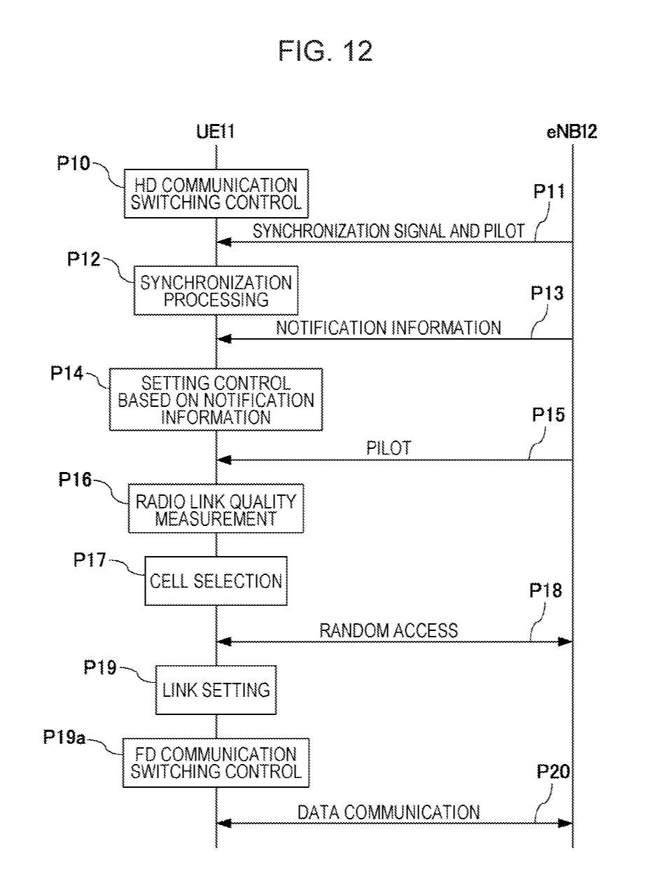

Hereinafter, with reference to FIGS. 12 to 15, description is given of operation examples of the radio communication system 1 according to this embodiment. Note that resources for the FD communication and the HD communication may be hereinafter referred to as the “FD resource” and “HD resource” for descriptive purposes.

The “FD resource” is an example of “first radio resource”, while the “HD resource” is an example of a second radio resource. Moreover, in FIGS. 12 to 15, processes denoted by the same reference numerals as those used in FIG. 6 may be the same as or similar to those described with reference to FIG. 6 unless otherwise noted.

### First Embodiment

FIG. 12 is a sequence diagram illustrating an operation example in a first example. In the first example, description is given of a case where the UE 11 already knows FD/HD switching control information.

“FD/HD switching control information” means, as an example, control information for the UE 11 to switch from the FD communication to the HD communication or from the HD communication to the FD communication, or control information for the UE 11 to selectively use the FD communication and the HD communication. Note that the “FD/HD switching control information” may be hereinafter referred to as “FD/HD control information”.

Non-limiting examples of the case where the UE 11 “already knows the FD/HD control information” are as follows.

(1) When the FD/HD control information is stored in a storage unit such as a ROM in the UE 11 at the time of manufacture of the UE 11.
(2) When the FD/HD control information is stored in a subscriber identity module (SIM) of the UE 11.
(3) When the UE 11 stores the FD/HD control information included in the notification information previously received from the eNB 12.

Note, however, that it is assumed in the first example that the UE 11 has no previous knowledge of control information regarding transmission of a synchronization signal and a pilot signal by the eNB 12.

As illustrated in FIG. 12, when the UE 11 has previous knowledge of the FD/HD control information, the UE 11 may perform HD communication switching control before receiving a synchronization signal or a pilot signal from the eNB 12 at the timing of power-on or the like (Process P10).

“HD communication switching” means switching from the FD communication to the HD communication in terms of time (for example, at the timing of subframe, or the like) according to the resource setting illustrated in FIG. 10 or 11, for example, or means switching the frequency band in use from the one for the FD communication to the one for the HD communication. Note that “HD communication switching” may include maintaining the HD communication.

Communication switching opposite to “HD communication switching” described above may be referred to as “FD communication switching” for descriptive purposes. For example, “FD communication switching” means switching from the HD communication to the FD communication in terms of time (for example, at the timing of subframe, or the like) or means switching the frequency band in use from the one for the HD communication to the one for the FD communication. Note that “FD communication switching” may include maintaining the FD communication.

The HD communication switching control enables the UE 11 to receive the synchronization signal, pilot signal, and notification information transmitted by the eNB 12 in Processes P11, P13, and P15, through the HD resources. Moreover, the UE 11 uses the HD resources to perform the RA procedure (Process P18).

After successfully performing the RA procedure, the UE 11 may perform radio channel setting (for example, RRC connection setting or the like) between the UE 11 and the eNB 12 (Process P19).

Upon completion of the radio channel setting, the UE 11 may switch from the HD communication to the FD communication by setting the FD communication based on the FD/HD control information (Process P19a). Thus, the UE 11 may communicate user data through the FD communication with the eNB 12 (Process P20).

### Second Embodiment

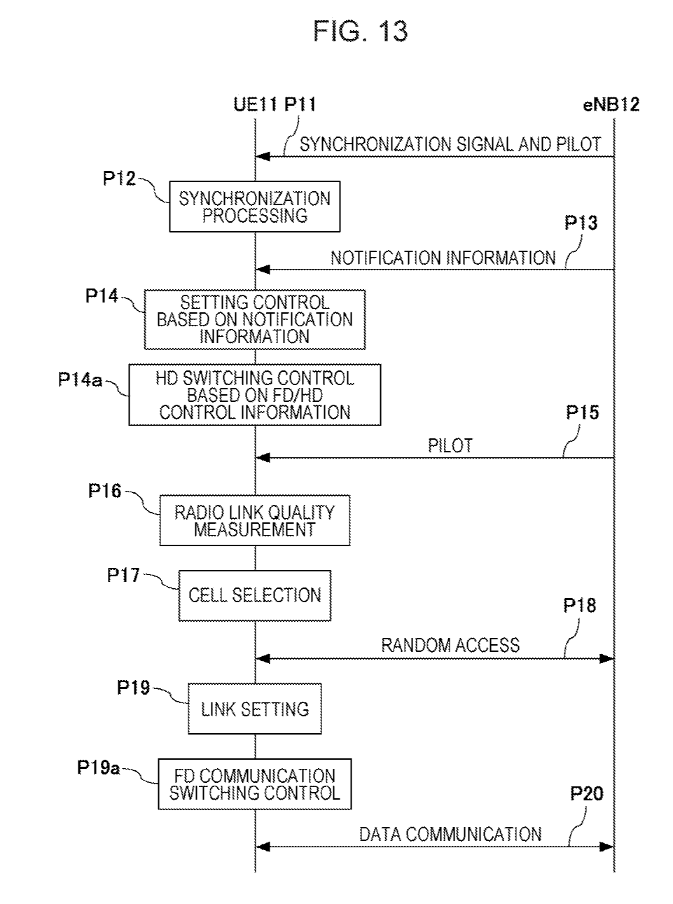

FIG. 13 is a sequence diagram illustrating an operation example in a second example. In the second example, it is assumed that the UE 11 has no previous knowledge of the FD/HD control information as in the case of the first example, but already knows control information regarding transmission of a synchronization signal and a pilot signal by the eNB 12.

Since the UE 11 has the previous knowledge of the control information regarding transmission of the synchronization signal and the pilot signal, the UE 11 does not have to perform Process P10 (HD communication switching control) in FIG. 12, as illustrated in FIG. 13.

The UE 11 performs the synchronization processing P12 by receiving the synchronization signal and the pilot signal transmitted by the eNB 12 in Process P11, as in the case of the first example, thereby achieving synchronization of DL communication with the eNB 12.

When the synchronization is achieved, the UE 11 is set in a ready state for receiving the notification information transmitted by the eNB 12 in Process P13. The eNB 12 may include the existing notification information and FD/HD control information in the notification information transmitted in Process P13.

Upon receipt of the notification information from the eNB 12, the UE 11 performs setting control based on the notification information as described with reference to FIG. 6 (Process P14) and may also perform HD communication switching control based on the FD/HD control information (Process P14a).

After the HD communication switching control, the UE 11 may perform DL radio channel quality measurement, cell selection, RA procedure, and radio channel setting, as in the case of Processes P15 to P19 described above with reference to FIG. 6.

Upon completion of the radio channel setting, the UE 11 may perform FD communication switching control to switch from the HD communication to the FD communication (Process P19a). Thus, the UE 11 may communicate user data through the FD communication with the eNB 12 (Process P20).

### Third Embodiment

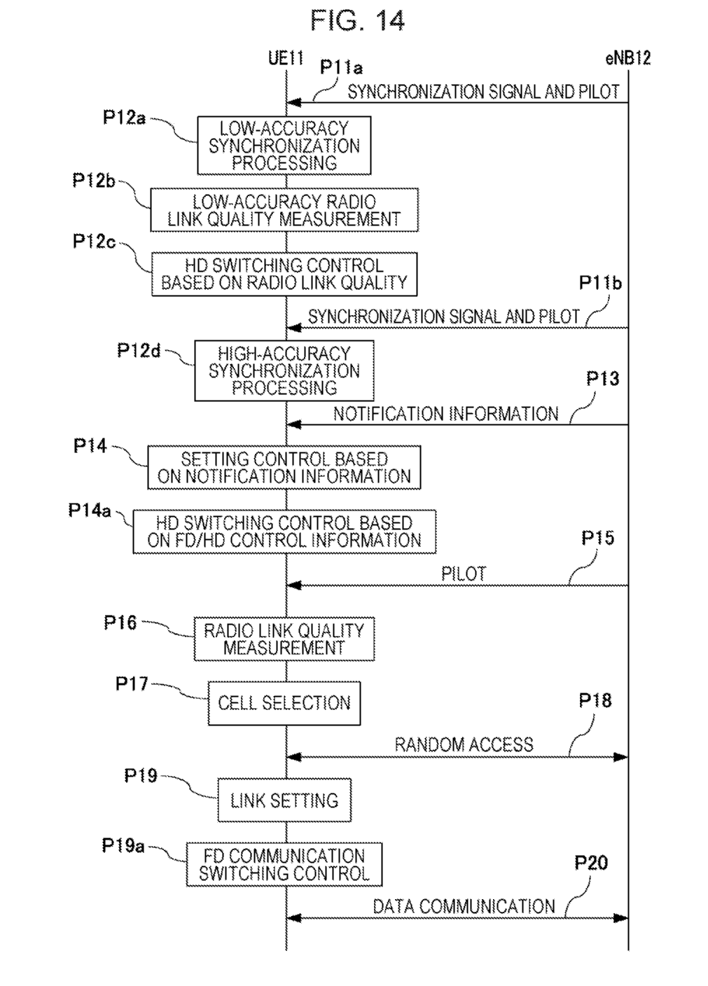

FIG. 14 is a sequence diagram illustrating an operation example in a third example. In the third example, unlike the first and second examples, it is assumed that the UE 11 has no previous knowledge of the FD/HD control information and also no previous knowledge of control information regarding transmission of a synchronization signal and a pilot signal by the eNB 12.

As illustrated in FIG. 14, the UE 11 may divide the synchronization processing described above into two stages, first synchronization processing (P12a) and second synchronization processing (P12d).

The second synchronization processing (P12d) has higher accuracy than the first synchronization processing (P12a), as an example. Thus, the first synchronization processing and the second synchronization processing may be referred to as “low-accuracy synchronization processing” and “high-accuracy synchronization processing”, respectively, for descriptive purposes.

The low-accuracy synchronization processing (P12a) may considered as allowing synchronization processing to be performed with lower synchronization accuracy than that for the existing synchronization processing, in a state where the synchronization signal and the pilot signal are transmitted through the FD resource (Process P11a) and interferences occur in the UE 11, for example.

After the low-accuracy synchronization processing, the UE 11 may perform low-accuracy radio channel quality measurement (Process P12b). For example, the UE 11 may measure the RSRP, RSRQ, CQI, or the like from the pilot signal transmitted by the eNB 12 in Process P11a. The measurement result may be said to be a “low-accuracy” measurement result, since interferences may occur in the received pilot signal.

After the low-accuracy radio channel quality measurement as described above, the UE 11 may perform HD switching control based on the measurement result (Process P12c). For example, the UE 11 may perform HD communication switching when it may be determined that the measurement result is not more than a certain threshold and that the DL radio channel quality is an unallowable level for the synchronization processing due to the influence of the interferences.

The HD communication allows the UE 11 to receive the synchronization signal and the pilot signal transmitted by the eNB 12 in Process P11b, in an interference-suppressed state. Therefore, the UE 11 may perform high-accuracy synchronization processing based on the synchronization signal and the pilot signal (Process P12d).

The high-accuracy synchronization processing allows the UE 11 to identify and recognize the exact timing (for example, subframe) and/or frequency band for the synchronization signal and the pilot signal transmitted from the eNB 12.

After successfully achieving the synchronization of DL communication between the UE 11 and the eNB 12 as described above, the UE 11 is set in a ready state for receiving the notification information transmitted by the eNB 12 in Process P13. As in the case of the second example, the eNB 12 may include the existing notification information and FD/HD control information in the notification information transmitted in Process P13.

Upon receipt of the notification information from the eNB 12, the UE 11 performs setting control based on the notification information as described with reference to FIG. 6 (Process P14) and may also perform HD communication switching control based on the FD/HD control information (Process P14a). The HD communication switching control may be maintaining the HD communication.

Thereafter, the UE 11 may perform DL radio channel quality measurement, cell selection, RA procedure, and radio channel setting, as in the case of Processes P15 to P19 described above with reference to FIG. 6.

Upon completion of the radio channel setting, the UE 11 may perform FD communication switching control to switch from the HD communication to the FD communication (Process P19a). Thus, the UE 11 may communicate user data through the FD communication with the eNB 12 (Process P20).

### Fourth Embodiment

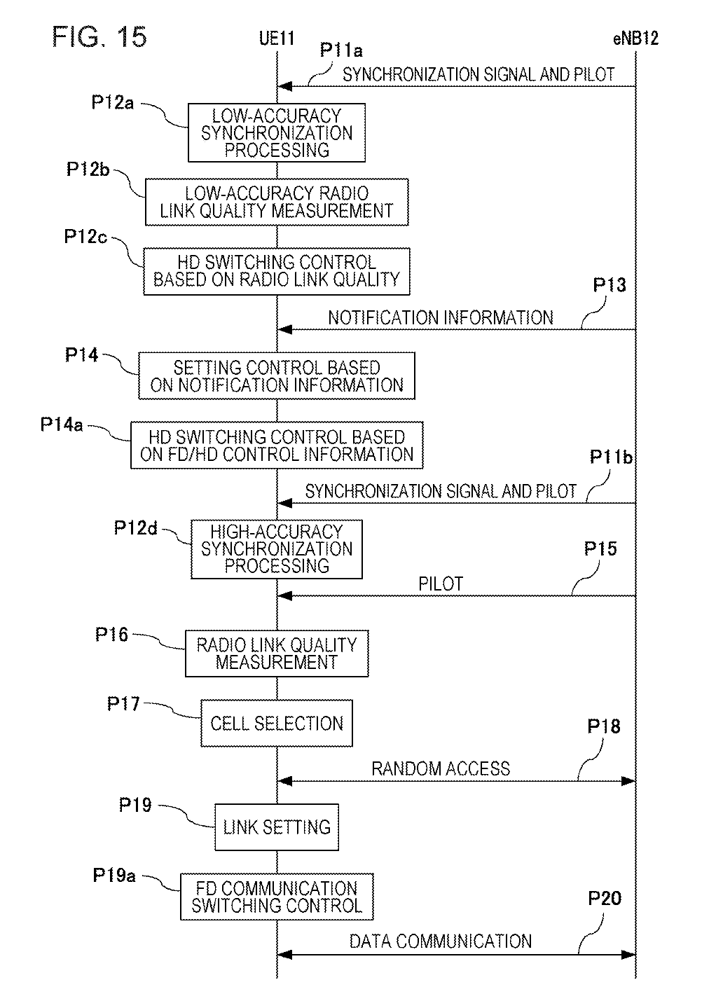

FIG. 15 is a sequence diagram illustrating an operation example in a fourth example. In the fourth example, as in the case of the third example, it is assumed that the UE 11 has no previous knowledge of the FD/HD control information and also no previous knowledge of control information regarding transmission of a synchronization signal and a pilot signal by the eNB 12.

FIG. 15 is different from FIG. 14 of the third example in that the high-accuracy synchronization processing P12d is performed after the HD communication switching control based on the FD/HD control information (Process P14a).

In other words, in the third example, the UE 11 receives the notification information (FD/HD control information) after performing the high-accuracy synchronization processing P12d. In the fourth example, on the other hand, the UE 11 performs the high-accuracy synchronization processing 12d after receiving the notification information (FD/HD control information).

In short, the UE 11 may perform the high-accuracy synchronization processing (P12d) before or after receiving the notification information including the FD/HD control information and performing the HD communication switching control based on the received FD/HD control information.

In the example of FIG. 15, the UE 11 may perform the high-accuracy synchronization processing (P12d) after the HD communication switching control (P14a), and may further perform DL radio channel quality measurement, cell selection, RA procedure, and radio channel setting, as in the case of Processes P15 to P19 in FIG. 6.

Upon completion of the radio channel setting, the UE 11 may perform FD communication switching control to switch from the HD communication to the FD communication (Process P19a). Thus, the UE 11 may communicate user data through the FD communication with the eNB 12 (Process P20).

As described above, according to the embodiment including the examples described above, the processing for starting normal communication with the eNB 12 may be ensured even when the UE 11 does not have any information regarding interference suppression processing, such as the scrambling code, and thus the interference suppression processing may not be performed.

(1) The synchronization accuracy may be improved since the UE 11 may receive the synchronization signal and the DL pilot signal (RS) from the eNB 12 in a state where interferences are suppressed in the HD communication, for example.

(2) The DL radio channel quality measurement accuracy may be improved since the UE 11 may receive the DL common pilot signal (Common RS or Cell specific RS) in a state where interferences are suppressed in the HD communication, for example. Therefore, the accuracy of cell selection by the UE 11 may be improved, for example. Moreover, since the DL radio channel quality measurement accuracy may be improved, the accuracy of DL scheduling performed by the eNB 12 using the measurement result may also be improved.

(3) The eNB 12 may improve the UL radio channel quality measurement accuracy by receiving UL sounding RS (SRS) in a state where interferences are suppressed in the HD communication, and, as a result, may improve the scheduling accuracy in the UL.

(4) The UE 11 may ensure the radio channel setting and the like between the UE 11 and the eNB 12, since the UE 11 may receive the system information and information regarding RRC from the eNB 12 in a state where interferences are suppressed in the HD communication.

(5) The success rate of the RA procedure may be improved, since the UL and DL transmissions may be performed in the RA procedure in a state where interferences are suppressed in the HD communication. Therefore, the UE 11 may easily ensure the radio channel setting.

(6) As an example of secondary effects achieved by the above (1) to (5), the time that takes to achieve synchronization between the UE 11 and the eNB 12 and the time that takes to set the radio channel may be shortened. Thus, a transmission rate and transmission efficiency between the UE 11 and the eNB 12 may be improved.

### GAP Setting

Incidentally, upon switching between the FD communication and the HD communication described above, the UE 11 and the eNB 12 control one or both of transmission and reception operations (which may be collectively referred to as “communication operation” for descriptive purposes), and thus perform setting related to the communication operation.

Upon switching from the FD communication to the HD communication, for example, the setting that enables only one of the transmission and reception operations is changed to the setting that enables both of the transmission and reception operations.

Upon switching from the HD communication to the FD communication, on the other hand, the setting that enables both of the transmission and reception operations is changed to the setting that enables only one of the transmission and reception operations. The switching from the HD communication to the FD communication corresponds to switching from communication where occurrence of interferences is suppressed to communication where occurrence of interferences is allowed. Therefore, in the FD communication after the switching, setting or control may be desired to perform interference suppression processing using the scrambling code described above, for example.

In order to perform the setting or control for the communication operation, the UE 11 and the eNB 12 may suspend the communication operation. In order to allow the suspension of the communication operation, a gap (GAP) where no communication is performed may be set in radio resources assignable to communication between the UE 11 and the eNB 12. For example, one or both of time and frequency band in which no communication is performed may be set in the radio resources assignable to communication between the UE 11 and the eNB 12.

### GAP Setting in FDD

In the FDD-based FD communication, communication is performed using the same frequency band for both of UL and DL. In the FDD, upon switching from the FD communication to the HD communication, some of the frequency bands are divided into UL and DL for use. Thus, both of the UE 11 and the eNB 12 control the transmission and reception operations. The GAP may be used for such control.

For example, upon switching from the FD communication to the HD communication in the FDD, it is expected to stop the interference suppression processing operated in the FD communication. Once the interference suppression processing stopped, adjacent channel power may make apparent interferences, for example.

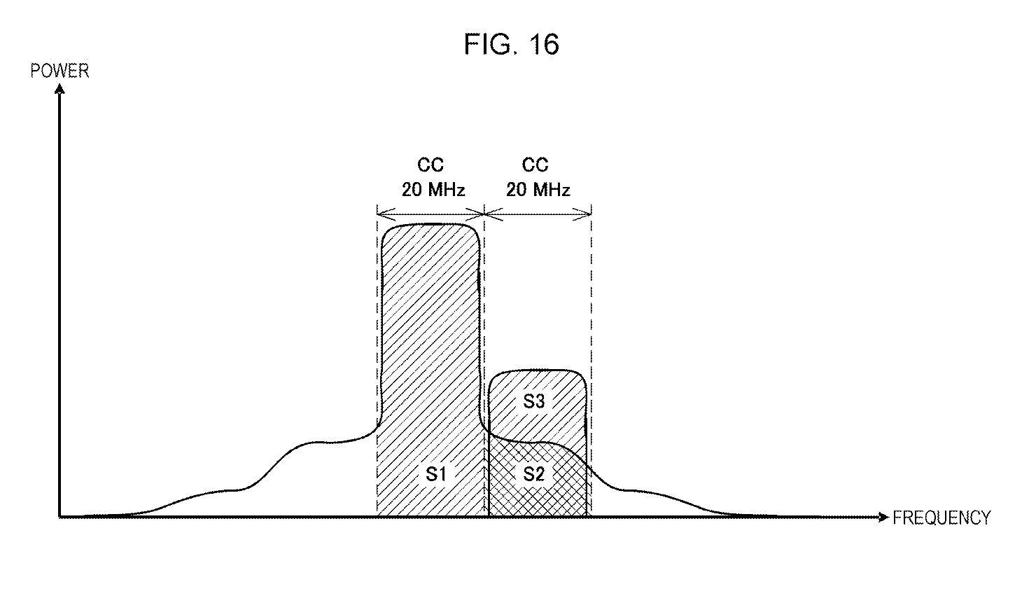

FIG. 16 illustrates a model example of interference caused by adjacent channel power. FIG. 16 illustrates an example of frequency to power characteristics based on adjacent two component carriers (CC #1 and #2).

FIG. 16 illustrates the example where at least some of side lobe power S2 relative to main lobe power S1 of CC #1 leaks to main lobe power S3 of the adjacent CC #2, thus causing interference.

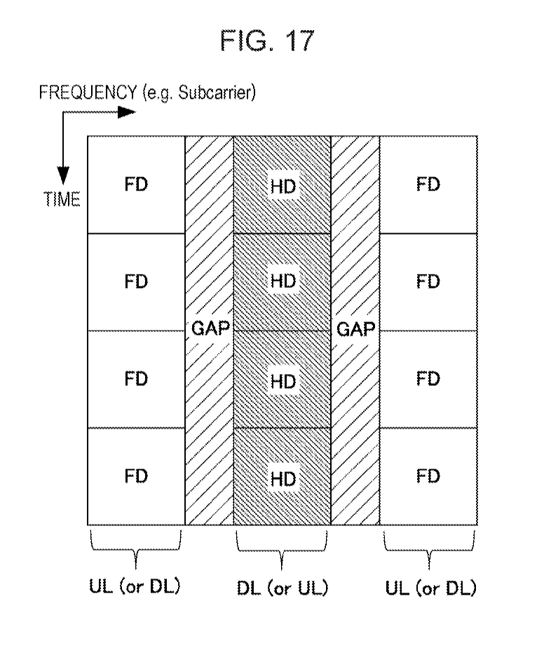

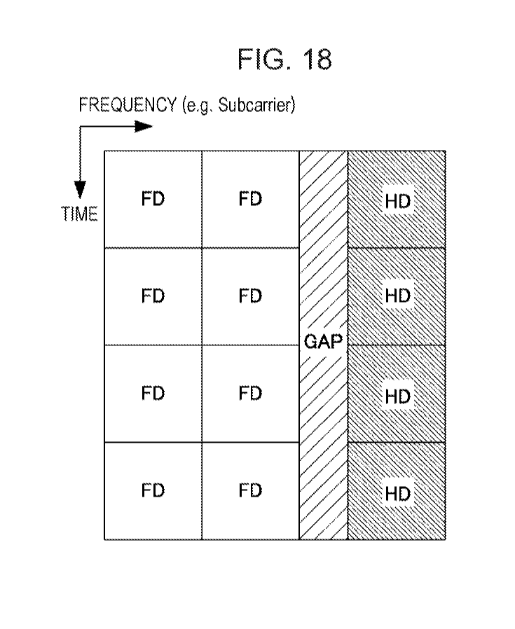

As measures against such interference caused by adjacent channel power, a frequency band (GAP) where no communication is performed may be provided in a frequency domain between the UL frequency band and the DL frequency band as illustrated in FIGS. 17 and 18, for example. The GAP corresponds to a third frequency band when one of the UL and DL frequency bands is considered to be a first frequency band and the other to be a second frequency band.

As an example, the time axis direction in FIGS. 17 and 18 may be considered as corresponding to the LTE subframe and the frequency axis direction may be considered as corresponding to the RB, CC, or SCB. Note that, as illustrated in FIG. 18, no GAP may be provided between frequency bands for the FD communication adjacent to each other in the frequency axis direction. This is because interferences may be removed or suppressed by the interference suppression processing. Note, however, that the GAP may be provided between the frequency bands for the FD communication.

### GAP Setting in TDD

In the case of TDD, a delay in DL transmission from the eNB 12 to the UE 11 and a delay in UL transmission from the UE 11 to the eNB 12 are taken into consideration. In the case of the DL transmission, due to a propagation delay, a signal transmitted by the eNB 12 reaches the UE 11 later than the transmission timing at the eNB 12.

Moreover, since the UE 11 starts the reception operation from the first timing of the received DL signal frame (for example, radio frame, subframe, or slot), the timing to start the reception operation differs between the eNB 12 and the UE 11.

Furthermore, in the UL transmission, the UE 11 performs the transmission operation earlier than the first timing of the received DL signal frame, taking into consideration a UL propagation delay, so that he first timing of the UL signal frame coincides with the timing to start the reception operation at the eNB 12.

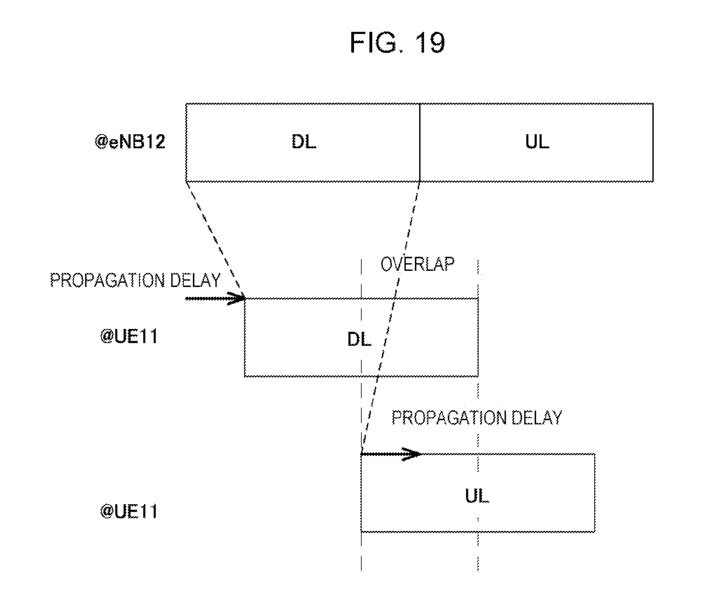

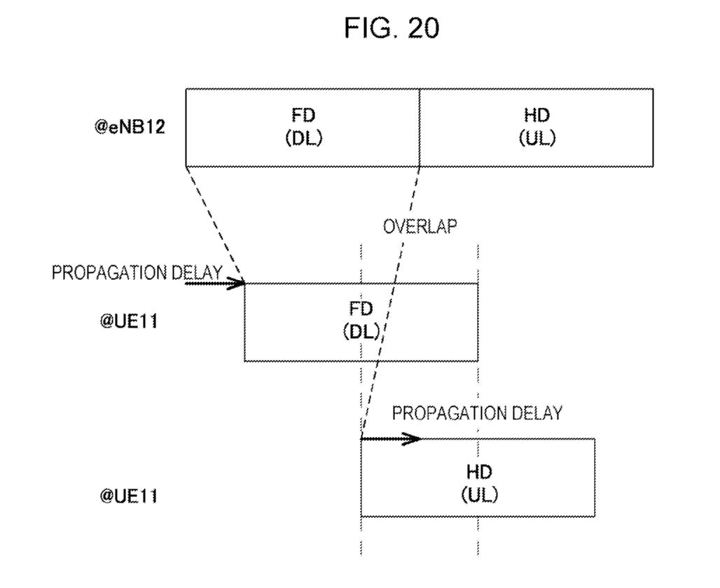

When neither the above two points are taken into consideration nor any GAP is set, the UL and DL signal frames may partially overlap with each other to cause interference, as schematically illustrated in FIG. 19, for example. Therefore, as schematically illustrated in FIG. 20, for example, when the eNB 12 and the UE 11 both switch from the FD communication to the HD communication, the DL signal frame in the FD communication and the UL signal frame in the HD communication may partially overlap with each other.

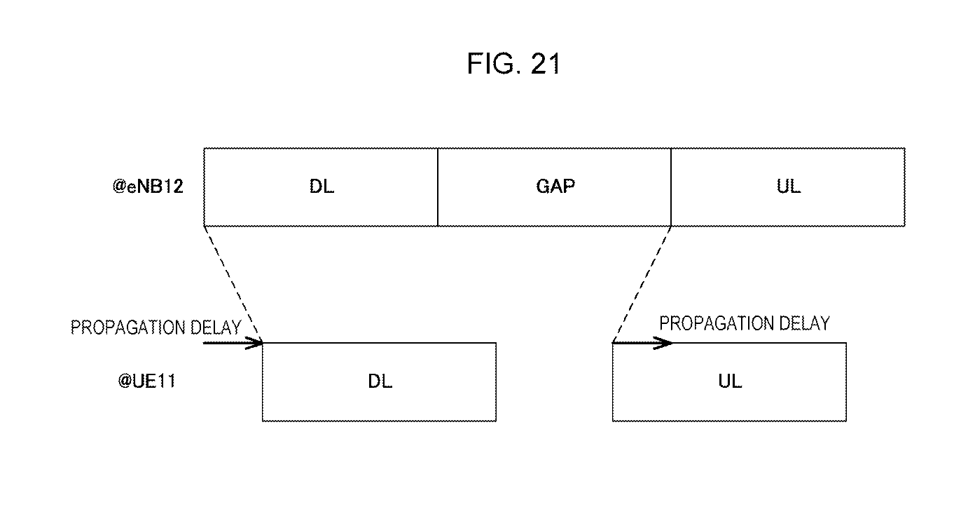

Then, as schematically illustrated in FIG. 21, for example, a GAP is set in the time domain between a DL time section corresponding to the DL signal frame length and a UL time section corresponding to the UL signal frame length. Thus, occurrence of interference in the DL and UL communications may be avoided or suppressed. Therefore, the interference suppression processing does not have to be performed in the HD communication.

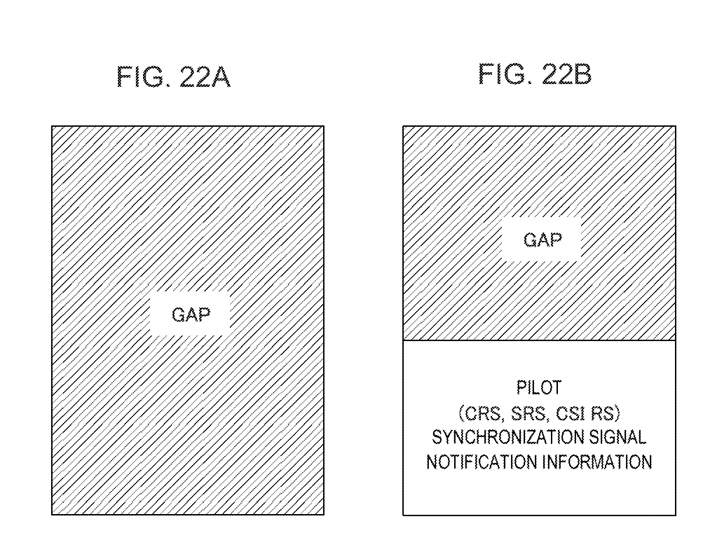

Note that the GAP set in the time domain may be referred to as a special subframe (SSF). The SSF may be a frame while entire field is the GAP as illustrated in FIG. 22A, or may be a frame having a GAP field and a field where other information may be set as illustrated in FIG. 22B.

Non-limiting examples of the “other information” include a pilot signal, a synchronization signal, notification information, and the like. The pilot signal may be any of common RS (CRS), sounding RS (SRS), and channel state information RS (CSI RS).

Note that the CRS, the synchronization signal, and the notification information are the signal or information used by the UE 11 to perform cell selection, as described above, and thus may be transmitted in the HD communication but may also be alternatively or additionally transmitted through the SSF.

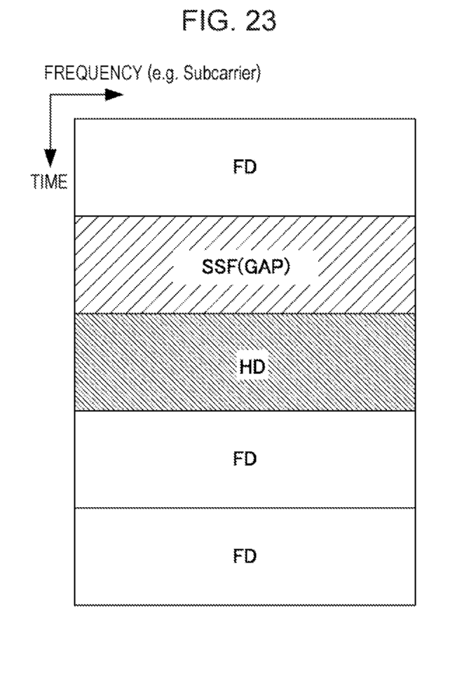

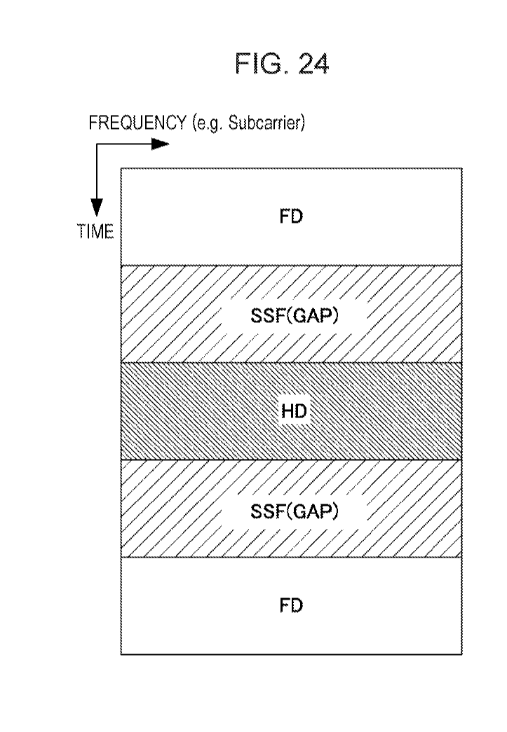

Moreover, the SSF may also be inserted or set for switching from the HD communication to the FD communication, as illustrated in FIG. 24, without being limited to switching from the FD communication to the HD communication (see, for example, FIG. 23) as described above.

The insertion or setting of the SSF for the switching from the HD communication to the FD communication may be optional. However, in order to avoid the occurrence of interference described with reference to FIGS. 19 and 20, it is preferable that the SSF is inserted and set for the switching from the FD communication to the HD communication.

Note that, in the example of FIG. 23, the time section of the FD communication is an example of a first time section, while the time section of the HD communication is an example of a second time section. Also, the GAP between the time section of the FD communication and the time section of the HD communication is an example of a third time section.

### GAP Setting by Combining TDD and FDD

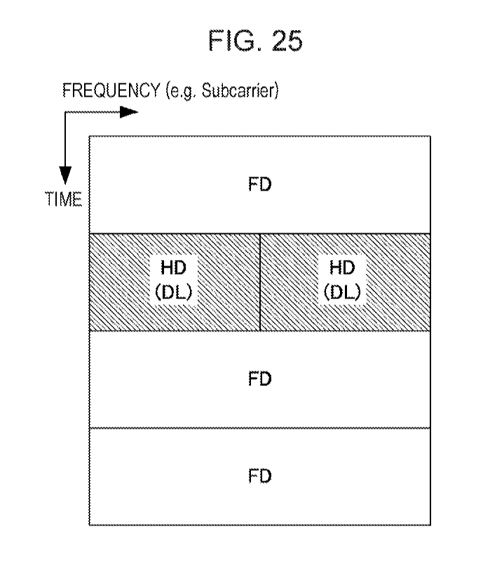

As illustrated in FIG. 25, for example, TDD-based HD communication may be performed, and FDD-based UL communication and DL communication may be performed in the HD communication. As an example, the time axis direction in FIG. 25 may be considered as corresponding to the LTE subframe and the frequency axis direction may be considered as corresponding to the RB, CC, or SCB.

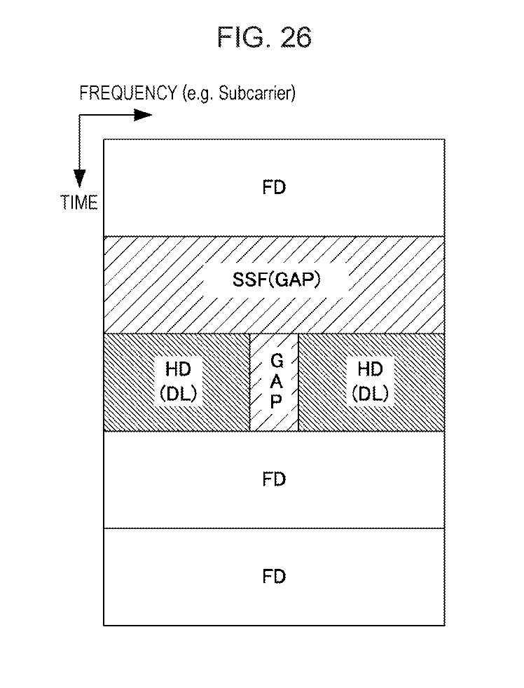

In the example of FIG. 25, neither GAP nor SSF is set. However, considering the transmission and reception operations taking into consideration the propagation delay as described above with reference to FIGS. 19 and 20, it is preferable that the SSF is inserted and set for switching from the FD communication to the HD communication as illustrated in FIG. 26, for example, as in the example of FIG. 23.

Moreover, considering the adjacent channel power described with reference to FIG. 16, it is preferable that the GAP is inserted and set between the frequency band for the UL communication and the frequency band for the DL communication, which are obtained by dividing the HD resources in the frequency domain, as illustrated in FIG. 26.

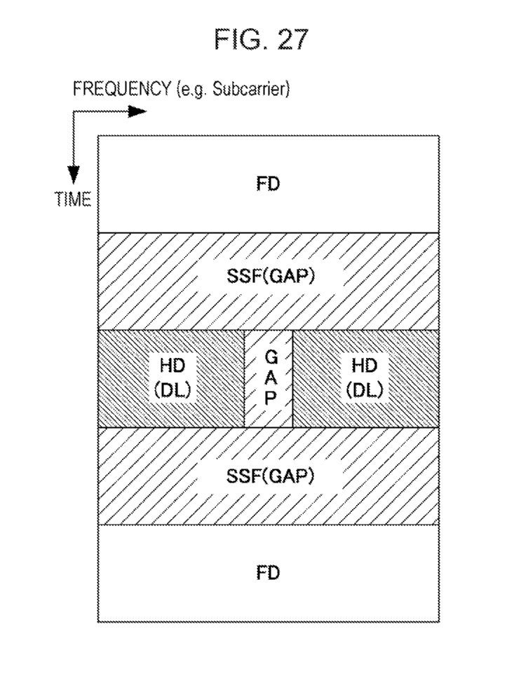

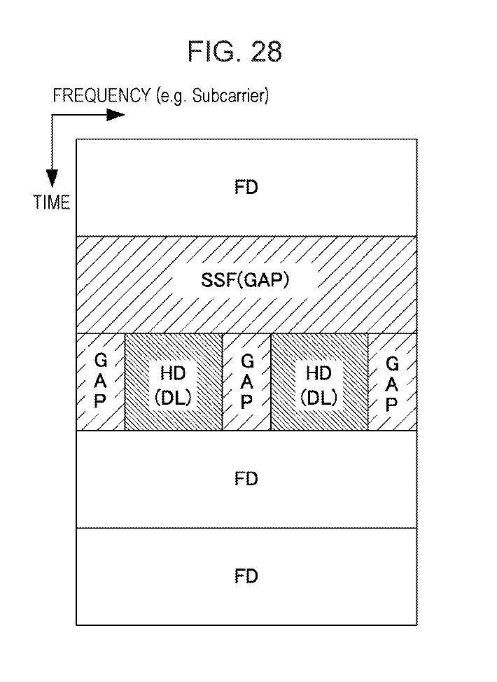

Note that, in the example of FIG. 25, again, the SSF may be inserted or set for switching from the HD communication to the FD communication, as illustrated in FIG. 27, without being limited to switching from the FD communication to the HD communication as in the example of FIG. 24. Moreover, as illustrated in FIG. 28, GAPs may be provided on either side of the frequency bands in the frequency axis direction, which are obtained by dividing the HD resources in the frequency domain, without being limited to between the divided frequency bands.

### Configuration Example of eNB 12 and UE 11

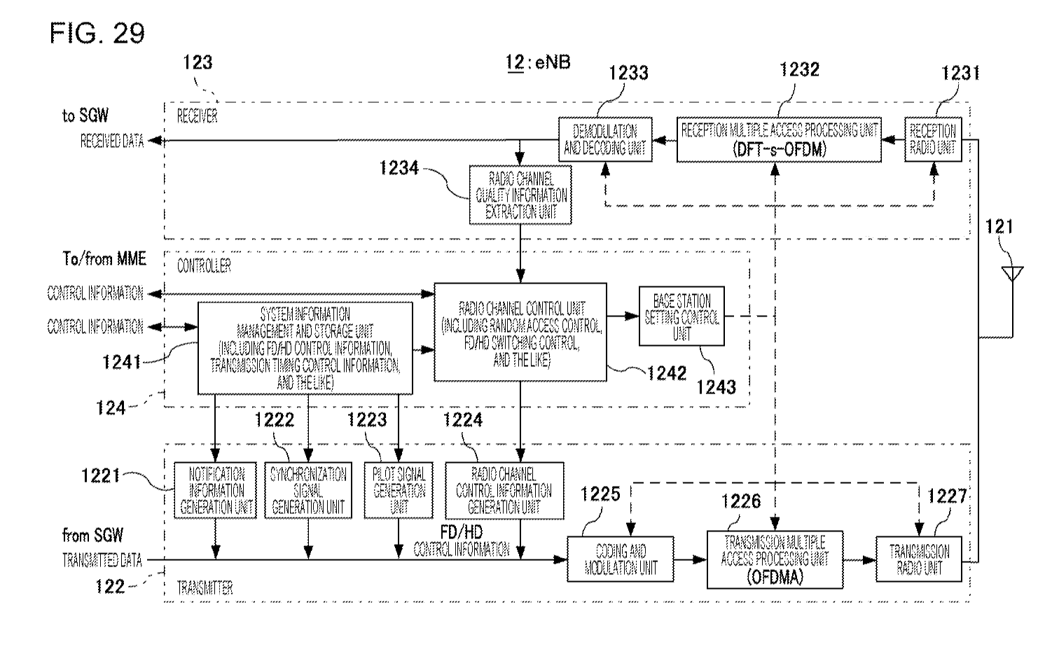

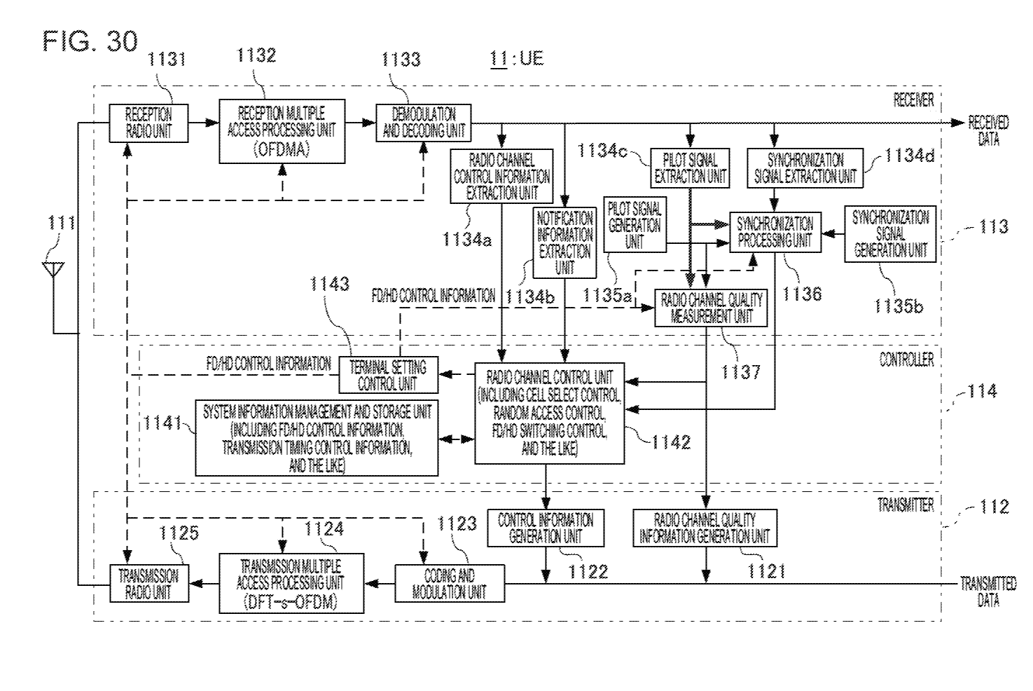

Next, with reference to FIGS. 29 to 34, description is given of several configuration examples of the UE 11 and the eNB 12 described above. Note that FIGS. 29, 31, and 33 are block diagrams illustrating a first configuration example, a second configuration example and a third configuration example of the eNB 12, respectively. FIGS. 30, 32, and 34 are block diagrams illustrating first to third configuration examples of the UE 11, corresponding to the first to third configuration examples of the eNB 12, respectively.

### First Configuration Example of eNB 12

As illustrated in FIG. 29, the eNB 12 may include, as an example, an antenna 121, a transmitter 122, a receiver 123, and a controller 124.

As an example, the antenna 121 radiates radio (RF) signals outputted from the transmitter 122 into space, receives the RF signals from space, and outputs the RF signals to the receiver 123. The antenna 121 is shared by the transmitter 122 and the receiver 123 in the example of FIG. 29, but may be separately provided.

As an example, the transmitter 122 generates a DL radio signal to be transmitted to the UE 11, and outputs the DL radio signal to the antenna 121.

As an example, the receiver 123 receives UL radio signals transmitted by the UE 11 and received by the antenna 121, and demodulates and decodes the received radio signals.

As an example, the controller 124 controls the operation of the transmitter 122 (in other words, DL transmission processing) and the operation of the receiver 123 (in other words, UL reception processing). Note that the “transmission processing” and “reception processing” may be considered to be synonymous with the “transmission operation” and “reception operation” described above.

As illustrated in FIG. 29, the transmitter 122 may include a notification (broadcast) information generation unit 1221, a synchronization signal generation unit 1222, a pilot signal generation unit 1223, and a radio channel control information generation unit 1224. As an example, the transmitter 122 may also include a coding and modulation unit 1225, a transmission multiple access processing unit 1226, and a transmission radio unit 1227.

The notification information generation unit 1221 generates, as an example, notification information by acquiring information to be notified (broadcast) to a radio area (for example, cell) provided by the eNB 12 from the controller 124 (for example, a system information management and storage unit 1241 to be described later).

For example, the notification information generation unit 1221 may generate notification information including system information, information regarding RRC, FD/HD control information, and the like, as described above.

As an example, the synchronization signal generation unit 1222 acquires a cell ID from the system information management and storage unit 1241, and generates a synchronization signal based on the acquired cell ID.

As an example, the pilot signal generation unit 1223 generates a pilot signal based on the cell ID acquired from the system information management and storage unit 1241.

As an example, the radio channel control information generation unit 1224 generates radio channel control information under the control of the controller 124 (for example, a radio channel control unit 1242 to be described later). The radio channel control information may include a message regarding the RA procedure and control information for controlling switching between the FD communication and the HD communication.

Note that some or all of the generation units 1221 to 1224 described above may be elements of the controller 124.

The coding and modulation unit 1225 codes and modulates, as an example, the signals or information generated by the notification information generation unit 1221, the synchronization signal generation unit 1222, the pilot signal generation unit 1223, and the radio channel control information generation unit 1224.

As an example, a coding system, a code rate, and a modulation method used by the coding and modulation unit 1225 may be controlled by the controller 124 (for example, a base station setting control unit 1243 to be described later or the radio channel control unit 1242).

The transmission multiple access processing unit 1226 maps, as an example, the signals inputted from the coding and modulation unit 1225 into a signal frame (for example, radio frame, subframe, or slot) corresponding to a multiple access scheme (for example, OFDMA) supported by the eNB 12.

The transmission radio unit 1227 generates, as an example, a DL radio signal by converting the frequency of the signal inputted from the transmission multiple access processing unit 1226 into a radio frequency. The DL radio signal may be accordingly amplified by the transmission radio unit 1227.

On the other hand, the receiver 123 may include, as an example, a reception radio unit 1231, a reception multiple access processing unit 1232, a demodulation and decoding unit 1233, and a radio channel quality information extraction unit 1234.

The reception radio unit 1231 may, as an example, convert the UL radio signal received by the antenna 121 into a baseband signal by accordingly amplifying the radio signal.

The reception multiple access processing unit 1232 may, as an example, separate a signal multiplexed onto the baseband signal inputted from the reception radio unit 1231 according to the multiple access scheme (for example, DFT-s-OFDM) supported by the eNB 12.

As an example, the demodulation and decoding unit 1233 demodulates the signal inputted from the reception multiple access processing unit 1232, and decodes the demodulated signal.

As an example, the radio channel quality information extraction unit 1234 extracts information regarding the radio channel quality from the decoded received signal. The information regarding the radio channel quality may be, as an example, the RSRP, RSRQ, CQI, or the like described above. The extracted information regarding the radio channel quality may be, as an example, inputted to the radio channel control unit 1242 for use in radio channel control.

Note that the radio channel quality information extraction unit 1234 may be one of the elements of the controller 124.

The controller 124 may include, as an example, the system information management and storage unit 1241, the radio channel control unit 1242, and the base station setting control unit 1243.

The system information management and storage unit 1241 stores and manages, as an example, system information, a cell ID, FD/HD control information, transmission timing information, and the like. The cell ID may be considered as being included in the system information. The FD/HD control information may be included in the notification information generated by the notification information generation unit 1221, as described above. Note that the information stored and managed by the system information management and storage unit 1241 may be accordingly transmitted and received through communication with a core node (for example, MME 32).

The radio channel control unit 1242 controls the radio channel between the UE 11 and the eNB12, as an example. The radio channel control may include, as an example, control for the RA procedure, control for switching between the FD communication and the HD communication, and the like. The information regarding the radio channel control may be accordingly transmitted and received through communication with the core node (for example, MME 32), as an example.

The base station setting control unit 1243 controls setting of one or both of the transmission operation of the transmitter 122 and the reception operation of the receiver 123, as an example.

The transmission operation setting control on the transmitter 122 may be, as an example, setting control on any one or more of the coding and modulation unit 1225, the transmission multiple access processing unit 1226, and the transmission radio unit 1227.

The setting control on the coding and modulation unit 1225 may include setting control for the coding system, the code rate, the modulation method, and the like.

The setting control on the transmission multiple access processing unit 1226 may include, as an example, setting control for the resources used for transmission of the DL signal frame (for example, one or both of the transmission timing and the transmission frequency band).

The setting control on the transmission radio unit 1227 may include, as an example, setting control for transmission power of the DL radio signal.

The reception operation setting control on the receiver 123 may be, as an example, setting control on any one or more of the reception radio unit 1231, the reception multiple access processing unit 1232, and the demodulation and decoding unit 1233.

The setting control on the reception radio unit 1231 may include, as an example, setting control for an amplification factor of the UL received radio signal.

The setting control on the reception multiple access processing unit 1232 may include, as an example, setting control for the resources to receive the UL signal frame (for example, one or both of the reception timing and the reception frequency band).

The setting control on the demodulation and decoding unit 1233 may include, as an example, setting control for demodulation and decoding processing corresponding to the modulation method, coding system, and code rate used for the UL radio signal transmitted by the UE 11.

In the above configuration, the operations of the transmitter 122 and the receiver 123 are switched by the controller 124 (for example, the base station setting control unit 1243) upon switching between the FD communication and the HD communication according to the FD/HD control information.

In the TDD-based (or FDD-based) FD communication, for example, the transmitter 122 and the receiver 123 may operate together. In the transmitter 122, the coding and modulation unit 1225, the transmission multiple access processing unit 1226, and the transmission radio unit 1227 may all operate. In the receiver 123, the reception radio unit 1231, the reception multiple access processing unit 1232, and the demodulation and decoding unit 1233 may all operate.

On the other hand, in the TDD-based (or FDD-based) HD communication, only one of the transmitter 122 and the receiver 123 may operate. When the transmitter 122 operates, the coding and modulation unit 1225, the transmission multiple access processing unit 1226, and the transmission radio unit 1227 may all operate. When the receiver 123 operates, the reception radio unit 1231, the reception multiple access processing unit 1232, and the demodulation and decoding unit 1233 may all operate.

In the FD communication, the controller 124 does not have to transmit the notification information, the synchronization signal, and the pilot signal used by the UE 11 for cell selection. Also, the controller 124 does not have to perform the control for the RA procedure and the control for the cell selection by the UE 11. Note, however, that the pilot signal used by the UE 11 to demodulate individual data may be transmitted.

In the HD communication, on the other hand, the controller 124 may transmit the notification information, the synchronization signal, and the pilot signal used by the UE 11 for cell selection, and may also perform the control for the RA procedure and the control for the cell selection by the UE 11.

In the FDD-based HD communication, the controller 124 may perform the control of the transmission radio resources, rather than the control of the transmission timing. The radio resources may be either RB or CC.

In the TDD-based HD communication, only for the HD resources (for example, subframe) to perform the HD communication, the controller 124 may transmit the notification information, the synchronization signal, and the pilot signal used by the UE 11 for cell selection, and may also perform the control for the RA procedure.

In the TDD, the controller 124 may switch between the HD communication and the FD communication in terms of time (for example, at the timing of subframe, or the like).

### First Configuration Example of UE 11

FIG. 30 is a block diagram illustrating the first configuration example of the UE 11 corresponding to the first configuration example of the eNB 12 illustrated in FIG. 29. As illustrated in FIG. 30, the UE 11 may include an antenna 111, a transmitter 112, a receiver 113, and a controller 114.

As an example, the antenna 111 radiates RF signals outputted from the transmitter 112 into space, receives the RF signals from space, and outputs the RF signals to the receiver 113. The antenna 111 is shared by the transmitter 112 and the receiver 113 in the example of FIG. 30, but may be separately provided.

As an example, the transmitter 112 generates a UL RF signal to be transmitted to the eNB 12, and outputs the RF signal to the antenna 111.

As an example, the receiver 113 receives DL RF signals transmitted by the eNB 12 and received by the antenna 111, and demodulates and decodes the received RF signals.

As an example, the controller 114 controls the operation of the transmitter 112 (in other words, UL transmission processing) and the operation of the receiver 113 (in other words, DL reception processing). Note that the “transmission processing” and “reception processing” may be considered to be synonymous with the “transmission operation” and “reception operation” described above.

The transmitter 112 may include, as an example, a radio channel quality information generation unit 1121, a control information generation unit 1122, a coding and modulation unit 1123, a transmission multiple access processing unit 1124, and a transmission radio unit 1125.

The radio channel quality information generation unit 1121 generates, as an example, information regarding radio channel quality (which may be hereinafter abbreviated as “radio channel quality information”) to be transmitted to the eNB 12, based on radio channel quality measured by a radio channel quality measurement unit 1137 to be described later. The “radio channel quality information” may be RSRP, RSRQ, CQI, or the like, as an example.

The control information generation unit 1122 generates, as an example, control information to be transmitted to the eNB 12 by acquiring information regarding radio channel control between the UE11 and the eNB 12 from the controller 114 (for example, a radio channel control unit 1142 to be described later).

The “radio channel control” may include, as an example, cell selection control, control for the RA procedure, RRC connection control, control for switching between the FD communication and the HD communication, and the like.

Note that one or both of the radio channel quality information generation unit 1121 and the control information generation unit 1122 may be an element or elements of the controller 114.

As an example, the coding and modulation unit 1123 codes and modulates input signals. The input signals to the coding and modulation unit 1123 may correspond to any one or more of the UL transmission data signal, the radio channel quality information generated by the radio channel quality information generation unit 1121, and the control information generated by the control information generation unit 1122.

Note that, as an example, a coding system, a code rate, and a modulation method used by the coding and modulation unit 1123 may be controlled by the controller 114 (for example, a terminal setting control unit 1143 to be described later or the radio channel control unit 1142).

The transmission multiple access processing unit 1124 maps, as an example, the signals inputted from the coding and modulation unit 1123 into a signal frame corresponding to a multiple access scheme (for example, DFT-s-OFDM) supported by the UE 11. The signal frame may be, as an example, a radio frame, subframe, slot, or the like.

The transmission radio unit 1125 generates, as an example, a UL RF signal by converting the frequency of the signal inputted from the transmission multiple access processing unit 1124 into a radio frequency. The UL RF signal may be accordingly amplified by the transmission radio unit 1125.

On the other hand, the receiver 113 in the UE 11 may include, as illustrated in FIG. 30, a reception radio unit 1131, a reception multiple access processing unit 1132, and a demodulation and decoding unit 1133. The receiver 113 may also include a radio channel control information extraction unit 1134a, a notification (broadcast) information extraction unit 1134b, a pilot signal extraction unit 1134c, and a synchronization signal extraction unit 1134d. The receiver 113 may further include a pilot signal generation unit 1135a, a synchronization signal generation unit 1135b, a synchronization processing unit 1136, and a radio channel quality measurement unit 1137.

The reception radio unit 1131 may, as an example, convert the DL RF signal received by the antenna 111 into a baseband signal by accordingly amplifying the RF signal.

The reception multiple access processing unit 1132 may, as an example, separate a signal multiplexed onto the baseband signal inputted from the reception radio unit 1131 according to the multiple access scheme (for example, OFDM) supported by the UE 11.

As an example, the demodulation and decoding unit 1133 demodulates the signal inputted from the reception multiple access processing unit 1132, and decodes the demodulated signal.

The radio channel control information extraction unit 1134a extracts, as an example, radio channel control information from the received signal decoded by the demodulation and decoding unit 1133. The radio channel control information may include, as an example, a message regarding the RA procedure and control information for controlling the switching between the FD communication and the HD communication. The extracted control information may be inputted to the controller 114 (for example, the radio channel control unit 1142 to be described later), as an example.

The notification information extraction unit 1134b extracts, as an example, notification information from the received signal decoded by the demodulation and decoding unit 1133. The extracted notification information may be inputted to the controller 114 (for example, the radio channel control unit 1142 to be described later), as an example.

The pilot signal extraction unit 1134c extracts, as an example, a pilot signal from the received signal decoded by the demodulation and decoding unit 1133. The extracted pilot signal (in other words, the received pilot signal) may be inputted to the synchronization processing unit 1136 and the radio channel quality measurement unit 1137, as an example.

The synchronization signal extraction unit 1134d extracts, as an example, a synchronization signal from the received signal decoded by the demodulation and decoding unit 1133. The extracted synchronization signal (in other words, the received synchronization signal) may be inputted to the synchronization processing unit 1136, as an example.

The pilot signal generation unit 1135a generates, as an example, a replica of the pilot signal known between the UE 11 and the eNB 12. The generated replica of the pilot signal may be inputted to the synchronization processing unit 1136 and the radio channel quality measurement unit 1137, as an example.

The synchronization signal generation unit 1135b generates, as an example, a replica of the synchronization signal known between the UE 11 and the eNB 12. The generated replica of the synchronization signal may be inputted to the synchronization processing unit 1136, as an example.

The synchronization processing unit 1136 performs synchronization processing based on a correlation between the received synchronization signal and the replica of the synchronization signal and a correlation between the received pilot signal and the replica of the pilot signal.

The synchronization processing may include symbol timing detection, scrambling code detection, frame timing detection, and the like. The information detected by the synchronization processing may be inputted to the controller 114 (for example, the radio channel control unit 1142 to be described later), as an example.

The radio channel quality measurement unit 1137 measures DL radio channel quality (for example, RSRP, RSRQ, CQI, or the like) based on the received pilot signal, as an example. The measurement result may be inputted to the controller 114 (for example, the radio channel control unit 1142 to be described later), as an example. The measurement result may also be inputted to the radio channel quality information generation unit 1121 in the transmitter 112 to be notified (fed back) to the eNB 12.

Note that some or all of the extraction units 1134a to 1134d, the generation units 1135a and 1135b, the synchronization processing unit 1136, and the radio channel quality measurement unit 1137 described above may be elements of the controller 114.

Next, the controller 114 in the UE 11 may include a system information management and storage unit 1141, the radio channel control unit 1142, and the terminal setting control unit 1143, as illustrated in FIG. 30.

The system information management and storage unit 1141 stores and manages the system information, the ID of the UE, the FD/HD control information, the transmission timing information, and the like, as an example. The ID of the UE may be a temporary ID assigned by the eNB 12.

The FD/HD control information may be, as an example, the previously provided information as described above or information included in the notification information extracted by the notification information extraction unit 1134b.

The radio channel control unit 1142 controls the radio channel between the UE11 and the eNB 12, as an example, based on the information stored and managed by the system information management and storage unit 1141, the information detected by the synchronization processing unit 1136, the notification information or control information extracted from the received signal, and the like. The radio channel control may include, as an example, control for cell selection, control for the RA procedure, control for switching between the FD communication and the HD communication, and the like.

The terminal setting control unit 1143 controls the setting of one or both of the transmission operation of the transmitter 112 and the reception operation of the receiver 113, as an example.

The transmission operation setting control on the transmitter 112 may be, as an example, setting control on any one or more of the coding and modulation unit 1123, the transmission multiple access processing unit 1124, and the transmission radio unit 1125.

The setting control on the coding and modulation unit 1123 may include setting control for the coding system, the code rate, the modulation method, and the like.

The setting control on the transmission multiple access processing unit 1124 may include, as an example, setting control for the resources used for transmission of the UL signal frame (for example, one or both of the transmission timing and the transmission frequency band).

The setting control on the transmission radio unit 1125 may include, as an example, setting control for transmission power of the UL RF signal.

The reception operation setting control on the receiver 113 may be, as an example, setting control on any one or more of the reception radio unit 1131, the reception multiple access processing unit 1132, the demodulation and decoding unit 1133, the synchronization processing unit 1136, and the radio channel quality measurement unit 1137.

The setting control on the reception radio unit 1131 may include, as an example, setting control for an amplification factor of the DL received RF signal.

The setting control on the reception multiple access processing unit 1132 may include, as an example, setting control for the resources to receive the DL signal frame (for example, one or both of the reception timing and the reception frequency band).

The setting control on the demodulation and decoding unit 1133 may include, as an example, setting control for demodulation and decoding processing corresponding to the modulation method, coding system, and code rate used for the DL RF signal transmitted by the eNB 12.

The setting control on one or both of the synchronization processing unit 1136 and the radio channel quality measurement unit 1137 may include, as an example, setting control for resources to perform one or both of the synchronization processing and the radio channel quality measurement according to the FD/HD control information.

As in the case of the eNB 12 having the configuration illustrated in FIG. 29, in the UE 11, again, the operations of the transmitter 112 and the receiver 113 are switched by the controller 114 (for example, the terminal setting control unit 1143) upon switching between the FD communication and the HD communication according to the FD/HD control information.

In the TDD-based (or FDD-based) FD communication, for example, the transmitter 112 and the receiver 113 may operate together. In the transmitter 112, the coding and modulation unit 1123, the transmission multiple access processing unit 1124, and the transmission radio unit 1125 may all operate. In the receiver 113, the reception radio unit 1131, the reception multiple access processing unit 1132, and the demodulation and decoding unit 1133 may all operate.

On the other hand, in the TDD-based (or FDD-based) HD communication, only one of the transmitter 112 and the receiver 113 may operate. When the transmitter 112 operates, the coding and modulation unit 1123, the transmission multiple access processing unit 1124, and the transmission radio unit 1125 may all operate. When the receiver 113 operates, the reception radio unit 1131, the reception multiple access processing unit 1132, and the demodulation and decoding unit 1133 may all operate.

In the FD communication, the controller 114 does not have to perform the control for the RA procedure and the control for the cell selection.

In the HD communication, on the other hand, the controller 114 may perform the control for the RA procedure and the control for the cell selection by the UE 11.

In the FDD-based HD communication, the controller 114 may perform the control of the reception radio resources, rather than the control of the reception timing. The radio resources may be either RB or CC.

In the TDD-based HD communication, only for the HD resources (for example, subframe) to perform the HD communication, the controller 114 may perform the control for the RA procedure.

In the TDD, the controller 114 may switch between the HD communication and the FD communication in terms of time (for example, at the timing of subframe, or the like).

### Second Configuration Example of eNB 12

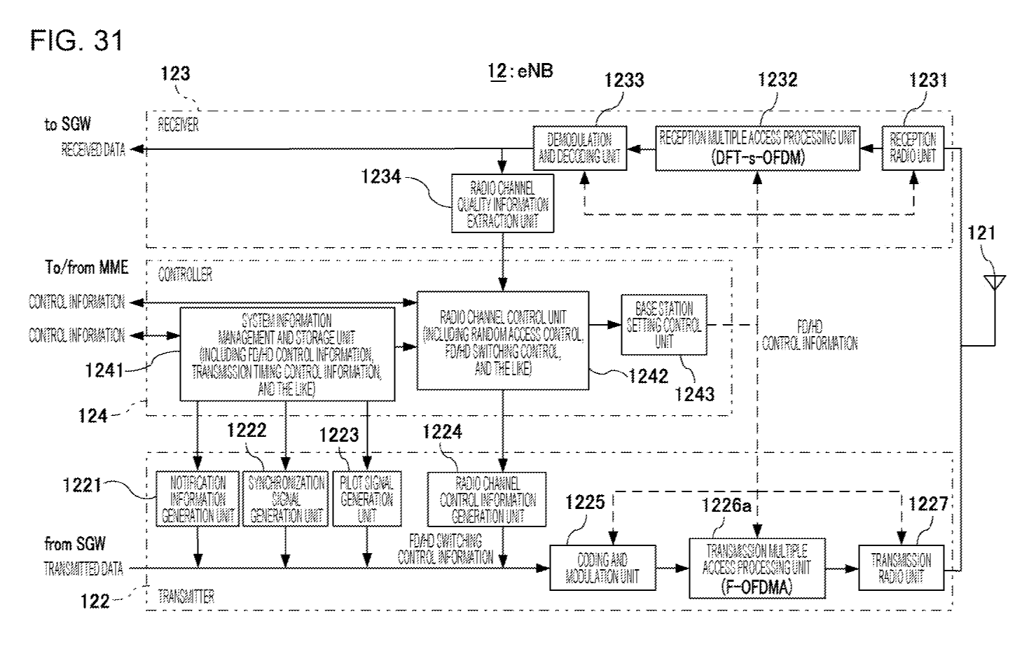

FIG. 31 is a block diagram illustrating the second configuration example of the eNB 12. The second configuration example illustrated in FIG. 31 is different from the first configuration example illustrated in FIG. 29 in that the DL transmitter 122 includes transmission multiple access processing unit 1226a instead of the transmission multiple access processing unit 1226.

As an example, the transmission multiple access processing unit 1226a supports the F-OFDMA scheme, and maps signals inputted from the coding and modulation unit 1225 into a signal frame (for example, a radio frame, subframe, or slot) compatible with F-OFDMA.

Since the eNB 12 of the second configuration example supports the F-OFDMA scheme for the DL communication, the controller 124 may add SCB to RB or CC as the control target for the transmission radio resources in the FDD-based HD communication. The other operation example in the FDD-based and/or TDD-based FD communication and HD communication may be the same as or similar to that of the first configuration example.

Note that the second configuration example illustrated in FIG. 31 is an example of supporting the F-OFDMA scheme for the DL transmission (transmission multiple access processing), but may alternatively or additionally support the F-OFDMA scheme for the UL reception (reception multiple access processing).

### Second Configuration Example of UE 1

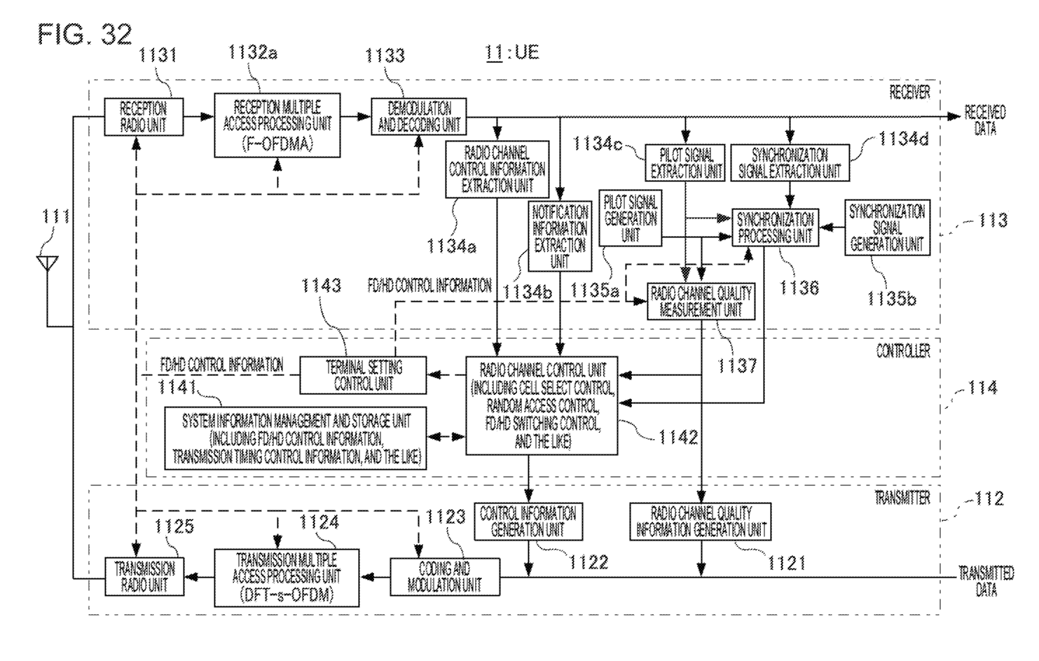

FIG. 32 is a block diagram illustrating the second configuration example of the UE 11. The second configuration example illustrated in FIG. 32 is a configuration example corresponding to the second configuration example of the eNB 12 illustrated in FIG. 31. Thus, the second configuration example of the UE 11 is different from the first configuration example of the UE 11 illustrated in FIG. 30 in that the DL receiver 113 includes a reception multiple access processing unit 1132a that supports the F-OFDMA scheme, instead of the reception multiple access processing unit 1132.

The reception multiple access processing unit 1132a may, as an example, separate a signal multiplexed onto the baseband signal inputted from the reception radio unit 1131 according to the F-OFDMA scheme.

Since the UE 11 of the second configuration example supports the F-OFDMA scheme for the DL reception, the controller 114 may add SCB to RB or CC as the control target for the reception radio resources in the FDD-based HD communication. The other operation example in the FDD-based and/or TDD-based FD communication and HD communication may be the same as or similar to that of the first configuration example.

Note that, as in the case of the second configuration example of the eNB 12, the UE 11 of the second configuration example may alternatively or additionally support the F-OFDMA scheme for the UL transmission (transmission multiple access processing).

### Third Configuration Example of eNB 12

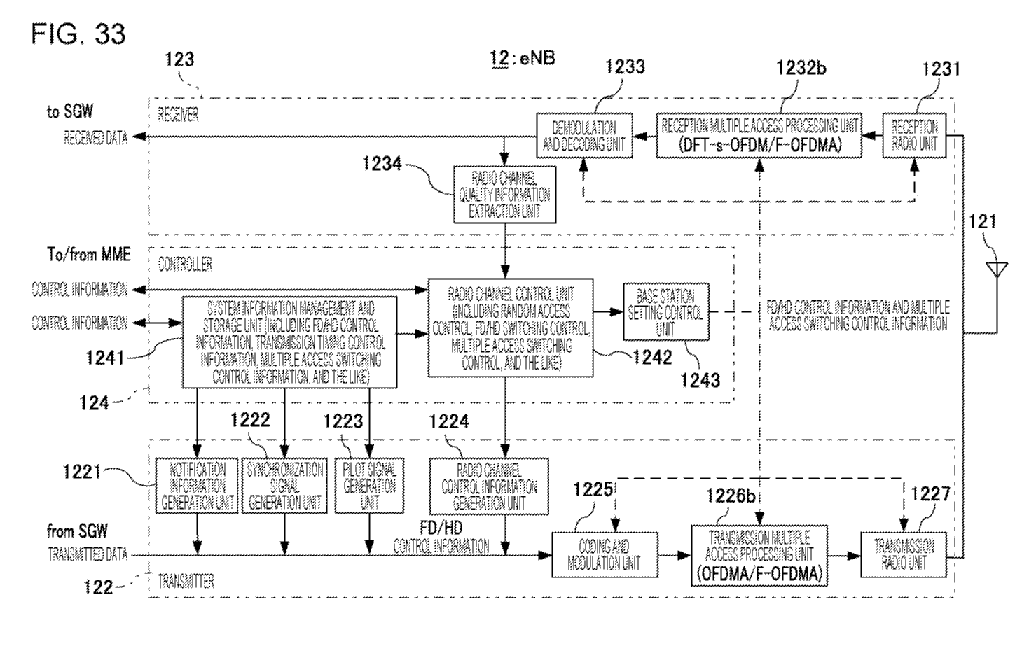

FIG. 33 is a block diagram illustrating the third configuration example of the eNB 12. The third configuration example illustrated in FIG. 33 is different from the first configuration example illustrated in FIG. 29 in supporting switching of the DL transmission multiple access processing scheme and switching of the UL reception multiple access processing scheme.

For example, the DL transmitter 122 includes a transmission multiple access processing unit 1226b capable of switching between the OFDMA scheme and the F-OFDMA scheme, for example, instead of the transmission multiple access processing unit 1226.

Likewise, the UL receiver 123 includes a reception multiple access processing unit 1232b capable of switching between the DFT-s-OFDMA scheme and the F-OFDMA scheme, for example, instead of the reception multiple access processing unit 1232.

Thus, the controller 124 in the third configuration example may control the switching of the multiple access processing scheme in the transmission multiple access processing unit 1226b and the switching of the multiple access processing scheme in the reception multiple access processing unit 1232b, in addition to the control of switching between the FD communication and the HD communication.

The control information for controlling the switching of the multiple access processing scheme (which may be abbreviated as the “multiple access switching control information” for descriptive purposes) may be stored and managed by the system information management and storage unit 1241, as an example.

Based on the multiple access switching control information stored and managed by the system information management and storage unit 1241, the radio channel control unit 1242 or the base station setting control unit 1243 may control the multiple access processing schemes in the transmission multiple access processing unit 1226b and the reception multiple access processing unit 1232b.

Moreover, the radio channel control unit 1242 may transmit the multiple access switching control information to the UE 11 through the radio channel control information generation unit 1224 in the DL transmitter 122. Upon receipt of the multiple access switching control information from the eNB 12, the UE 11 may switch the multiple access processing scheme for the UL transmission and the DL reception in response to switching of the multiple access processing in the eNB 12.

The other operation example in the FDD-based and/or TDD-based FD communication and HD communication may be the same as or similar to that of the first configuration example.

Note that the third configuration example illustrated in FIG. 33 is a configuration example capable of switching the multiple access processing scheme for both of the DL transmission and the UL reception, but may be capable of switching the multiple access processing scheme only for one of the DL transmission and the UL reception.

### Third Configuration Example of UE 11

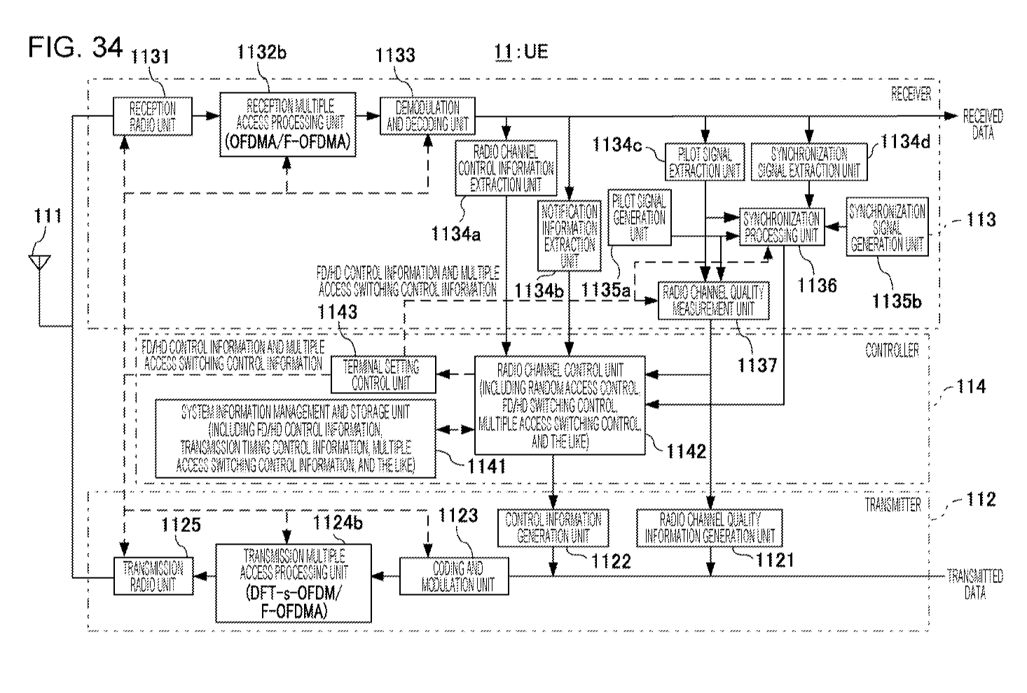

FIG. 34 is a block diagram illustrating the third configuration example of the UE 11. The third configuration example illustrated in FIG. 34 is a configuration example corresponding to the third configuration example of the eNB 12 illustrated in FIG. 33. Thus, the third configuration example of the UE 11 is different from the first configuration example illustrated in FIG. 30 in supporting switching of the UL transmission multiple access processing scheme and switching of the DL reception multiple access processing scheme.

For example, the UL transmitter 112 includes a transmission multiple access processing unit 1124b capable of switching between the DFT-s-OFDMA scheme and the F-OFDMA scheme, for example, instead of the transmission multiple access processing unit 1124.

Likewise, the DL receiver 113 includes a reception multiple access processing unit 1132b capable of switching between the OFDMA scheme and the F-OFDMA scheme, for example, instead of the reception multiple access processing unit 1132.

Thus, the controller 114 in the third configuration example may control both of the switching of the multiple access processing scheme in the transmission multiple access processing unit 1124b and the switching of the multiple access processing scheme in the reception multiple access processing unit 1132b, in addition to the control of switching between the FD communication and the HD communication.

The multiple access switching control information may be stored and managed by the system information management and storage unit 1141, as an example. The multiple access switching control information may also be the previously provided information or information included in the control information extracted by the radio channel control information extraction unit 1134a.

Based on the multiple access switching control information, the radio channel control unit 1142 or the terminal setting control unit 1143 may control switching of the multiple access processing scheme, in addition to the control of switching between the FD communication and the HD communication.

As an example, the terminal setting control unit 1143 may control the setting for the resources used for transmission of the UL signal frame (for example, one or both of the transmission timing and the transmission frequency band) based on the FD/HD control information and the multiple access switching control information.

Likewise, the terminal setting control unit 1143 may control the setting for the resources to receive the DL signal frame (for example, one or both of the reception timing and the reception frequency band) based on the FD/HD control information and the multiple access switching control information.

Furthermore, the terminal setting control unit 1143 may control the setting for the resources to perform one or both of the synchronization processing by the synchronization processing unit 1136 and the radio channel quality measurement by the radio channel quality measurement unit 1137, based on the FD/HD control information and the multiple access switching control information.

The other operation example in the FDD-based and/or TDD-based FD communication and HD communication may be the same as or similar to that of the first configuration example.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A radio communication system comprising:
a base station configured to set a first radio resource for performing full duplex communication and a second radio resource for performing half duplex communication in one frequency band; and
a radio terminal configured to communicate with the base station by using at least one of the first radio resource and the second radio resource.

2. The radio communication system according to claim 1, wherein
the first radio resource is a first time section of a plurality of time sections obtained by dividing the one frequency band in a time domain, and the second radio resource is a second time section of the plurality of time sections.

3. The radio communication system according to claim 2, wherein
the second radio resource is one frequency band of a plurality of frequency bands obtained by dividing the second time section in a frequency domain.

4. The radio communication system according to claim 1, wherein
the first time section and the second time section correspond to subframe lengths in a radio frame, respectively.

5. The radio communication system according to claim 1, wherein
the one frequency band is a system band,
the first radio resource is a first frequency band of a plurality of frequency bands obtained by dividing the system band in a frequency domain,
the second radio resource is a second frequency band of the plurality of frequency bands, and
the radio terminal performs the full duplex communication with the base station in the first frequency band, and performs the half duplex communication in the second frequency band.

6. The radio communication system according to claim 1, wherein
the one frequency band corresponds to any one of a system band, a resource block, a component carrier, and a subcarrier block.

7. The radio communication system according to claim 1, wherein
the base station uses the second radio resource to transmit a synchronization signal to the radio terminal.

8. The radio communication system according to claim 1, wherein
the base station uses the second radio resource to transmit a pilot signal to the radio terminal.

9. The radio communication system according to claim 1, wherein
the base station uses the second radio resource to transmit notification information to the radio terminal.

10. The radio communication system according to claim 1, wherein
the base station uses the second radio resource to perform a random access procedure with the radio terminal.

11. The radio communication system according to claim 2, wherein
the base station sets a third time section where no communication is performed, between the first time section and the second time section.

12. The radio communication system according to claim 11, wherein
the third time section is set by a special subframe.

13. The radio communication system according to claim 5, wherein
the base station sets a third frequency band where no communication is performed, between the first frequency band and the second frequency band.

14. A base station comprising:
a transmitter configured to generate a downlink radio signal and transmit the downlink radio signal to a radio terminal;
a receiver configured to receive an uplink radio signal from the radio terminal and demodulate and decode the uplink radio signal; and
a control circuit configured to control a transmission processing of the downlink radio signal for the transmitter and a reception processing of the uplink radio signal for the receiver so as to communicate with the radio terminal by using at least one of a first radio resource for performing full duplex communication and a second radio resource for performing half duplex communication, which are set in one frequency band.

15. A radio terminal comprising:
a transmitter configured to generate an uplink radio signal and transmit the uplink radio signal to a base station;
a receiver configured to receive a downlink radio signal from the base station and demodulate and decode the downlink radio signal; and
a control circuit configured to control a transmission processing of the uplink radio signal for the transmitter and a reception processing of the downlink radio signal for the receiver so as to communicate with the base station by using at least one of a first radio resource for performing full duplex communication and a second radio resource for performing half duplex communication, which are set by the base station in one frequency band.
